(19) United States
(12) Patent Application Publication
(10) Pub. No.: US 2025/0360412 A1
(43) Pub. Date: Nov. 27, 2025

(54) PROGRAM, INFORMATION PROCESSING SYSTEM, AND INFORMATION PROCESSING METHOD

(71) Applicant: CYGAMES, INC., Tokyo (JP)

(72) Inventors: Mamoru Takahashi, Tokyo (JP); Masato Nishi, Tokyo (JP); Yohei Yamagishi, Tokyo (JP); Yuka Tanaka, Tokyo (JP); Masashi Kachi, Tokyo (JP); Nobushige Takahashi, Tokyo (JP)

(73) Assignee: CYGAMES, INC., Tokyo (JP)

(21) Appl. No.: 19/293,537

(22) Filed: Aug. 7, 2025

Related U.S. Application Data
(63) Continuation of application No. PCT/JP2024/002263, filed on Jan. 25, 2024.

(30) Foreign Application Priority Data
Feb. 21, 2023 (JP) 2023-025597

(51) Int. Cl. A63F 13/57

(52) U.S. Cl. CPC A63F 13/57

(57) ABSTRACT

Provided are a program, an information processing system, and an information processing method for reducing a player's burden of repeatedly executing games. On the basis of a result of nurturing a character, factor information to be tied to said character is decided, and the factor information tied to the nurtured character affects an ability of a character serving as a nurturing object. An event parameter is updated in the case where a game that uses the nurtured character is executed, a factor-changing item serving as a right to change factor information can be earned in the case where the event parameter satisfies a predetermined condition, and the factor information tied to the nurtured character can be changed by consuming the factor-changing item.

### CROSS-REFERENCE TO RELATED APPLICATIONS

This application is a continuation of International Patent Application No. PCT/JP2024/002263, having an international filing date of Jan. 25, 2024, which designated the United States, the entirety of which is incorporated herein by reference. Japanese Patent Application No. 2023-025597 filed on Feb. 21, 2023 is also incorporated herein by reference in its entirety.

### BACKGROUND OF THE INVENTION

The present invention relates to a program, an information processing system, and an information processing method for a game in which specific information is associated with a game medium.

There are well-known games that provide a nurturing function for nurturing a game medium such as a character (refer to Publication of Japanese Patent No. 7035123). For example, in Publication of Japanese Patent No. 7035123, according to the result of nurturing a character, which is a game medium serving as a nurturing object, specific information is imparted to the character for which nurturing is completed, so that the character can be used for the next round of character nurturing.

However, in games for providing such a nurturing function, players are given only a limited chance to earn specific information at the completion of nurturing and thus need to repeatedly execute games many times by using the nurturing function until they can earn desired specific information. This burden of repeatedly executing games may discourage players from executing games continually if they have difficulty taking enough time to execute games.

### SUMMARY OF THE INVENTION

The present invention has been conceived in light of the above-described circumstances, and an object thereof is to provide a program, an information processing system, and an information processing method for reducing a player's burden of repeatedly executing games.

According to a first aspect of the disclosure, there is provided a program for a game in which specific information tied to a nurtured game medium affects an ability of a game medium serving as a nurturing object, the program causing a computer to function as:
a specific information decision unit for deciding, on the basis of a result of nurturing the game medium serving as a nurturing object, the specific information to be tied to said game medium;
a parameter update unit for updating a specific parameter in the case where a game that uses the nurtured game medium is executed;
a change-right earning control unit for allowing earning of a right to change the specific information in the case where the specific parameter satisfies a predetermined condition; and
a specific information change unit for allowing the specific information tied to the nurtured game medium to be changed by consuming the right to change the specific information.

According to a second aspect of the disclosure, there is provided an information processing system for a game in which specific information tied to a nurtured game medium affects an ability of a game medium serving as a nurturing object, the information processing system comprising:
a specific information decision unit for deciding, on the basis of a result of nurturing the game medium serving as a nurturing object, the specific information to be tied to said game medium;
a parameter update unit for updating a specific parameter in the case where a game that uses the nurtured game medium is executed;
a change-right earning control unit for allowing earning of a right to change the specific information in the case where the specific parameter satisfies a predetermined condition; and
a specific information change unit for allowing the specific information tied to the nurtured game medium to be changed by consuming the right to change the specific information.

According to a third aspect of the disclosure, there is provided an information processing method for a game in which specific information tied to a nurtured game medium affects an ability of a game medium serving as a nurturing object, the information processing method causing a computer to execute:
a specific information decision step for deciding, on the basis of a result of nurturing the game medium serving as a nurturing object, the specific information to be tied to said game medium;
a parameter update step for updating a specific parameter in the case where a game that uses the nurtured game medium is executed;
a change-right earning control step for allowing earning of a right to change the specific information in the case where the specific parameter satisfies a predetermined condition; and
a specific information change step for allowing the specific information tied to the nurtured game medium to be changed by consuming the right to change the specific information.

### BRIEF DESCRIPTION OF DRAWINGS

FIG. 1 is a drawing showing the overall configuration of an information processing system.

FIG. 2 is a functional block diagram of a server, among the functions realized in the information processing system.

FIG. 3 is a functional block diagram of a player terminal, among the functions realized in the information processing system.

FIG. 4 is a flowchart showing an example of processing related to a nurturing function for nurturing a character.

FIG. 5 is a drawing showing an example of a nurturing-character selection screen displayed in the player terminal.

FIG. 6 is a drawing showing an example of an inheritance-character selection screen displayed in the player terminal.

FIG. 7 is a drawing showing an example of an inheritance-character list screen displayed in the player terminal.

FIG. 8 is a drawing showing an example of the inheritance-character selection screen displayed in the player terminal.

FIG. 9 is a drawing showing an example of the inheritance-character selection screen displayed in the player terminal.

FIG. 10 is a drawing showing an example of a support organization screen displayed in the player terminal.

FIG. 11 is a drawing showing an example of a final confirmation screen displayed in the player terminal.

FIG. 12 is a drawing showing an example of a nurturing home screen displayed in the player terminal.

FIG. 13 is a flowchart showing an example of processing related to decision of factor information.

FIG. 14 is a drawing showing an example of a final confirmation dialog displayed in the player terminal.

FIG. 15 is a drawing showing an example of an earned-factor notification screen displayed in the player terminal.

FIG. 16 is a drawing showing an example of a factor-determination confirmation dialog displayed in the player terminal.

FIG. 17 is a drawing showing an example of a factor re-earning confirmation dialog displayed in the player terminal.

FIG. 18 is a drawing showing an example of an earning-factor selection screen displayed in the player terminal.

FIG. 19 is a drawing showing an example of the earning-factor selection screen displayed in the player terminal.

FIG. 20 is a drawing showing an example of a factor list dialog displayed in the player terminal.

FIG. 21 is a drawing showing an example of the factor-determination confirmation dialog displayed in the player terminal.

FIG. 22 is a drawing showing an example of parameter update presentation executed in the player terminal.

FIG. 23 is a drawing showing an example of parameter update presentation executed in the player terminal.

FIG. 24 is a drawing showing an example of parameter update presentation executed in the player terminal.

FIG. 25 is a flowchart showing an example of processing related to a factor changing function for changing factor information.

FIG. 26 is a drawing showing an example of a home screen displayed in the player terminal.

FIG. 27 is a drawing showing an example of reward-earning presentation executed in the player terminal.

FIG. 28 is a drawing showing an example of reward-earning presentation executed in the player terminal.

FIG. 29 is a drawing showing an example of reward-earning presentation executed in the player terminal.

FIG. 30 is a drawing showing an example of a reward list dialog displayed in the player terminal.

FIG. 31 is a drawing showing an example of an event top screen displayed in the player terminal.

FIG. 32 is a drawing showing an example of a function guidance dialog displayed in the player terminal.

FIG. 33 is a drawing showing an example of a character selection screen displayed in the player terminal.

FIG. 34 is a drawing showing an example of the character selection screen displayed in the player terminal.

FIG. 35 is a drawing showing an example of a selected-character confirmation dialog displayed in the player terminal.

FIG. 36 is a drawing showing an example of a strengthening-object selection screen displayed in the player terminal.

FIG. 37 is a drawing showing an example of a strengthening stage selection screen displayed in the player terminal.

FIG. 38 is a drawing showing an example of a strengthening content confirmation dialog displayed in the player terminal.

FIG. 39 is a drawing showing an example of completion notification presentation executed in the player terminal.

### DETAILED DESCRIPTION OF THE INVENTION

(1) The present embodiment relates to a program for a game in which specific information tied to a nurtured game medium affects an ability of a game medium serving as a nurturing object, the program causing a computer to function as: a specific information decision unit for deciding, on the basis of a result of nurturing the game medium serving as a nurturing object, the specific information to be tied to said game medium; a parameter update unit for updating a specific parameter in the case where a game that uses the nurtured game medium is executed; a change-right earning control unit for allowing earning of a right to change the specific information in the case where the specific parameter satisfies a predetermined condition; and a specific information change unit for allowing the specific information tied to the nurtured game medium to be changed by consuming the right to change the specific information.

(2) In the program according to the present embodiment, the specific information change unit may allow, on an input interface with which a change object of the specific information is selected, only the specific information belonging to a predetermined category to be selected as a change object.

(3) In the program according to the present embodiment, the specific information change unit does not need to allow selection of the specific information belonging to the predetermined category on the input interface if said specific information does not satisfy a change permission condition.

(4) The present embodiment relates to an information processing system for a game in which specific information tied to a nurtured game medium affects an ability of a game medium serving as a nurturing object, the information processing system including: a specific information decision unit for deciding, on the basis of a result of nurturing the game medium serving as a nurturing object, the specific information to be tied to said game medium; a parameter update unit for updating a specific parameter in the case where a game that uses the nurtured game medium is executed; a change-right earning control unit for allowing earning of a right to change the specific information in the case where the specific parameter satisfies a predetermined condition; and a specific information change unit for allowing the specific information tied to the nurtured game medium to be changed by consuming the right to change the specific information.

(5) The present embodiment relates to an information processing method for a game in which specific information tied to a nurtured game medium affects an ability of a game medium serving as a nurturing object, the information processing method causing a computer to execute: a specific information decision step for deciding, on the basis of a result of nurturing the game medium serving as a nurturing object, the specific information to be tied to said game medium; a parameter update step for updating a specific parameter in the case where a game that uses the nurtured game medium is executed; a change-right earning control step for allowing earning of a right to change the specific information in the case where the specific parameter satisfies a predetermined condition; and a specific information change step for allowing the specific information tied to the nurtured game medium to be changed by consuming the right to change the specific information.

In the aforementioned program, information processing system, and information processing method according to the present invention, because specific information tied to a game medium on the basis of a result of nurturing the game medium can be changed on condition that a change right is consumed, it is possible to reduce a player's burden of repeatedly executing nurturing of a game medium until specific information desired by the player is obtained.

An embodiment of the present invention will be described below. Note that the embodiment described below does not unjustifiably limit the content of the invention as specified in the claims. Furthermore, not all the components described in the context of this embodiment are necessarily indispensable elements constituting the present invention.

### 1. Configuration of Information Processing System

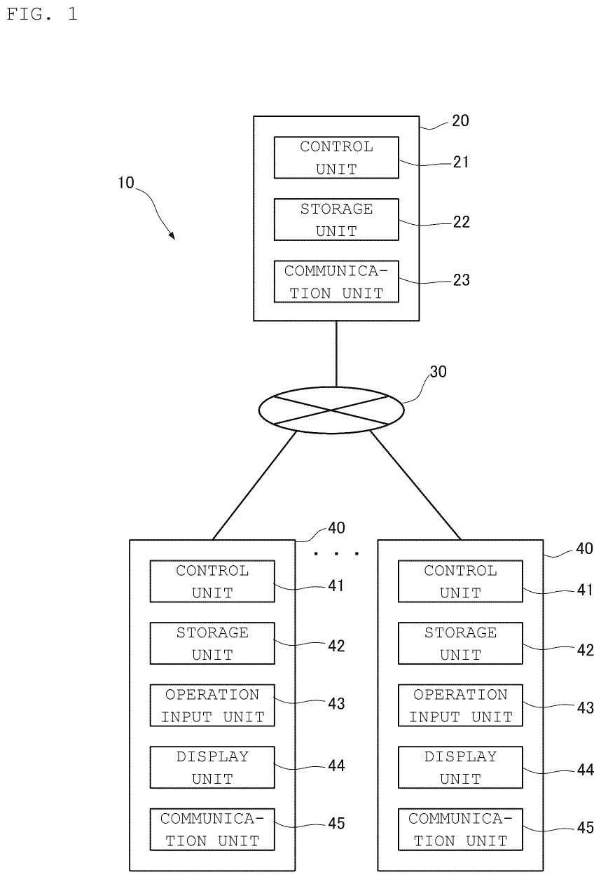

FIG. 1 is a drawing showing the overall configuration of an information processing system 10 according to this embodiment. As shown in FIG. 1, in the information processing system 10, a server 20 and a plurality of player terminals 40 are connected via a network 30, such as the Internet, a mobile phone network, a LAN, or a WAN, whereby what is called a client-server communication system is configured. Furthermore, each of the plurality of player terminals 40 carries out communication mutually with the server 20 via the network 30 to transmit and receive various kinds of information. In addition, each of the plurality of player terminals 40 carries out communication mutually with the other player terminals 40 via the network 30 and the server 20 to transmit and receive various kinds of information.

The server 20 includes: a control unit 21 constituted of a processor, such as a CPU; a storage unit 22 constituted of a main storage device, such as a ROM or a RAM, and an auxiliary storage device, such as an HDD or an SSD; and a communication unit 23 constituted of a communication module or a communication interface. In the server 20, the control unit 21 executes various kinds of processing according to programs stored in the storage unit 22. In addition, the server 20, by means of the communication unit 23, receives information from the player terminals 40 and transmits, to the player terminals 40, information, etc., concerning the results of processing executed by the control unit 21.

Each of the player terminals 40 is a smartphone, a tablet, a personal computer, a portable game machine, a stationary game machine installed in a store or a home, or the like. Each of the player terminals 40 includes: a control unit 41 constituted of a processor, such as a CPU; a storage unit 42 constituted of a main storage device, such as a ROM or a RAM, and an auxiliary storage device, such as a flash memory, an HDD, or an SDD; an operation input unit 43 constituted of a touchscreen, a keyboard, a microphone, etc.; a display unit 44 constituted of a liquid crystal display, an organic EL display, or the like; and a communication unit 45 constituted of a communication module or a communication interface. Each of the player terminals 40 also executes various kinds of processing according to programs stored in the storage unit 42. In addition, each of the player terminals 40, by means of the communication unit 45, receives information from the server 20 and transmits information to the server 20 and other player terminals 40.

The information processing system 10 according to this embodiment has a function for providing, through the player terminals 40, a game in which a character based on a racehorse motif is nurtured and the nurtured character is made to enter in a race to compete with other characters. In particular, the information processing system 10 according to this embodiment has a nurturing function for nurturing a character, a competition function for causing the nurtured character to compete with other characters in a race, a factor changing function for changing factor information (an example of specific information) tied to a nurtured character, etc. The following descriptions assume that the nurturing function, the competition function, and the factor changing function are realized mainly by a player terminal 40. It should be noted, however, that the aforementioned functions may be realized mainly by the server 20 or realized so as to be shared among the server 20 and the player terminal 40.

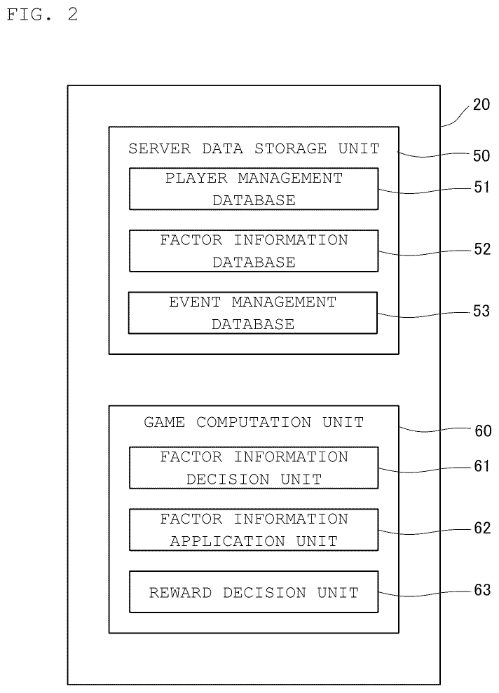

FIG. 2 is a functional block diagram showing main functions of the server 20.

The server 20 in the information processing system 10 has a function for managing players, characters, etc. on the basis of various kinds of identification information, as well as a function for executing computation needed to proceed with the game in response to requests from the player terminals 40 and transmitting results of the computation to the player terminals 40. These functions are realized by a server data storage unit 50 and a game computation unit 60 in a cooperative manner.

The server data storage unit 50 includes a player management database 51 and is realized mainly by the storage unit 22. In this embodiment, a character list, an item list, a nurturing object list, etc. are stored in the player management database 51 so as to be tied to a player ID imparted to each of the players.

The character list includes, for example: a character individual ID imparted to each nurtured character; a character type ID indicating the type of the character; statuses of the character (rarity, evaluation score, course aptitudes, distance aptitudes, running style aptitudes, way of running, speed, stamina, power, spirit, wisdom, possessed skills, earned title, and factor information); a lock state (locked and unlocked); and nurturing history of the character (nurturing conditions (information concerning selection of inheritance characters, information concerning organization of support items, etc.) and competition records in entry races during nurturing), etc.

In this embodiment, the phrase “nurtured character” refers to a character that has been nurtured by means of the nurturing function, which is one of the game functions realized in the information processing system 10 according to this embodiment, and that has statuses determined as a result of the nurturing being completed.

In addition, in this embodiment, the phrases “character individual ID” and “character type ID” are used, and they differ from each other as follows.

First, a “character individual ID” is an ID that is imparted to a character when nurturing of the character is completed in the nurturing function and the nurtured character is registered in the character list, and is used to identify each of the nurtured characters tied to the player ID.

Furthermore, this embodiment is designed so that the player selects a nurturing object from a plurality of kinds of characters in the nurturing function, and a “character type ID” is an ID imparted to identify the kind of the character serving as a nurturing object.

In addition, the “lock state” imparted to a nurtured character indicates whether or not the transfer (deletion from the character list) of the nurtured character is prohibited, and the character can be transferred when unlocked and cannot be transferred when locked. Examples of the situation in which a nurtured character is locked include a case where the nurtured character is individually specified by the player in the list of nurtured characters, a case where the nurtured character is entry-registered in a race, and so on.

The nurturing object list stores data indicating which information of “released” and “un-released” is associated with each of the character type IDs. In this embodiment, a character with which the information of “released” is associated in the nurturing object list is a character that can be selected by the player as a nurturing object in the nurturing function. Furthermore, in this embodiment, a character can be newly released by means of a releasing item and a character earning lottery, and the number of characters that can be selected as nurturing objects differs depending on the player. In the following, a character that can be selected as a nurturing object in the nurturing function may be referred to as a “released character”.

The item list includes data concerning: items possessed by the player; strengthening points; trainer points (TP); and in-game currency. In this embodiment, for example, the content of possessed items, the number of possessed items, the amount of possessed strengthening points, the amount of possessed trainer points (TP), the amount of possessed in-game currency, etc. are stored in the player management database 51 as the item list.

An item in this embodiment is used to, for example, support character nurturing and change race entry conditions, and can be acquired according to race results, can be acquired by consuming in-game currency, etc. In particular, in this embodiment, a factor-changing item is provided as an item that allows a change in factor information to be tied to a nurtured character. A factor-changing item is available in association with a factor-strengthening event that allows the factor changing function to be used only during a limited time period. More specifically, an event parameter can be accumulated by using the nurturing function and the competition function in a time period during which a factor-strengthening event is held. When the event parameter satisfies a reward earning condition, a reward decided by lottery can be earned. A factor-changing item is an object to be won by lottery as a reward, and a factor-changing item can be earned when a lottery is won. Also, a factor-changing item can be used through the factor changing function in a time period during which a factor-strengthening event is held.

Furthermore, strengthening points are used, for example, to strengthen a support item, which is an item for supporting character nurturing, and the more strengthened the support item, the more advantageous the nurturing environment in which the character can be nurtured.

In addition, trainer points (TP) are points used to nurture a character by using the nurturing function. In starting character nurturing, it is possible to start the character nurturing by consuming the trainer points (TP) corresponding to the consumption necessary for one round of character nurturing. Moreover, in this embodiment, trainer points (TP) also need to be consumed when factor information to be tied to a character is re-earned after the end of the character nurturing.

Another item of data that is stored in the player management database 51 is a friend list. In this embodiment, the player can register other players as friends and thereby, in the nurturing function, can use a character and a support item rented from the other players registered as friends. Friend registration of another player is achieved by inputting the player ID of the player on a friend registration screen displayed on the display unit 44 of the player terminal 40 and then, in the case where the player corresponding to the player ID is available and can be registered as a friend, by making a tap input to a registration button provided on the friend registration screen. By doing so, the player ID of the other player to be registered as a friend is added to the friend list. There is an upper limit (e.g., 50) set on the number of friend registrations (the number of friend registrations) for each of the players, and there is also an upper limit (e.g., 100) set on the number of players by whom one player can be registered as a friend (the number of friend-registering players). For this reason, if neither the number of friend-registering players for another player the present player wishes to register as a friend nor the number of friend registrations for the present player reaches the respective upper limits, the present player can newly register the other player as a friend.

Also, the server data storage unit 50 includes a factor information database 52, which stores information, such as a factor name, a factor level, and a factor type, so as to tie the information to a factor ID. In this embodiment, factors with the same factor name but different factor levels are assigned different factor IDs. Factor information is information tied to a nurtured character in the case where the character is nurtured by means of the nurturing function. In this embodiment, on the basis of the factor information tied to the nurtured characters that have been selected as inheritance characters when a character is to be nurtured in the nurturing function, a factor inheritance event occurs as a game event for status reinforcement that affects abilities of the character serving as a nurturing object, such as an increase in skill acquisition levels and an increase in performance parameters.

Factor information includes four categories of factors: blue factor, red factor, unique factor, and white factor. Each item of factor information has three factor levels set therefor, and as the factor level of factor information is higher, the factor information can bring about an effect more advantageous in status reinforcement. Furthermore, the factor type is a detailed classification of the blue factor, red factor, unique factor, and white factor. The blue factor is factor information bearing the name of performance parameter and affects performance parameters. The higher the factor level, the larger the amount of increase in performance parameters. The red factor is factor information bearing the name of course aptitude, distance aptitude, or running style aptitude and affects the course aptitude, distance aptitude, or running style aptitude. The higher the factor level, the more easily the aptitude increases with a factor inheritance event. The unique factor is factor information bearing the name of unique skill and allows the acquisition of the unique skills of the inheritance characters. The higher the factor level, the more easily the acquisition level of the unique skill increases. The acquisition level of a skill affects the consumption of skill points when the skill is to be acquired, and the higher the acquisition level, the smaller the amount of consumption of skill points. The white factor is factor information belonging to none of the blue factor, red factor, and unique factor and includes a skill factor, a race factor, and a scenario factor. A skill factor is factor information bearing the name of skill, makes it easier to increase the acquisition level of normal skills (skills other than unique skills), and exists for each kind of skill. A race factor is factor information bearing the name of race, makes it easier to increase at least either a performance parameter or the acquisition level of a normal skill, and brings about effects that differ depending on the kind of race. A scenario factor is factor information bearing the name of nurturing scenario and is factor information concerning the nurturing scenario with which the character has been nurtured. In the case where a scenario factor is to be inherited by means of a factor inheritance event, it is possible to greatly increase a plurality of performance parameters, and which performance parameters are increased differ depending on the kind of the scenario factor. Furthermore, according to the aforementioned factor type, factor information is classified into six kinds: blue factor, red factor, unique factor, skill factor, race factor, and scenario factor.

In addition, the server data storage unit 50 includes an event management database 53. The event management database 53 stores various kinds of data concerning a factor-strengthening event that are managed for each player, and the data to be managed includes at least a time setting table, the event parameter, a reward setting table, and reward earning data.

The time setting table is a data table related to a time period during which a factor-strengthening event is held, and defines at least an event start date/time and an event end date/time.

The event parameter (an example of a specific parameter) is a parameter that is referenced when it is determined whether or not a reward decision lottery for deciding a reward in association with a factor-strengthening event is to be drawn. In this embodiment, in the case where a character is nurtured by means of the nurturing function, the event parameter is updated. Furthermore, in this embodiment, in the case where a nurtured character is made to enter in a race in the competition function, the event parameter is updated. Also, in this embodiment, the reward decision lottery is drawn on the basis of sampling without replacement (so-called box lottery) in which the number of provided rewards is limited. In the case where the event parameter satisfies an execution condition for the reward decision lottery (reward earning condition) when an input for transitioning to the factor changing function is accepted, a reward decision lottery is drawn, and a reward to be provided to the player is decided on the basis of the result of the reward decision lottery. Note that the reward decision lottery may be a lottery based on sampling with replacement (so-called complete probability lottery) in which the number of provided rewards is not limited.

The reward setting table is data based on which an object to be won by a reward decision lottery is set. In this embodiment, each of the rewards that can be provided by a reward decision lottery is assigned a reward ID, and the content of a reward tied to a reward ID is set in the reward setting table.

Reward earning data is data for managing a reward earning situation in a factor-strengthening event. In this embodiment, each of the rewards provided via a reward decision lottery is managed for each player so as to be tied to a reward ID for identifying the reward, and reward earning data indicating reward IDs earned by each player is stored in the event management database 53.

The game computation unit 60 executes processing for computation needed to proceed with the game in response to a request from the player terminal 40 and for transmitting the result of computation to the player terminal 40, processing for transmitting, to the player terminal 40, data needed to proceed with the game in response to a request from the player terminal 40, etc. The game computation unit 60 is realized mainly by the control unit 41 and the communication unit 45. For example, upon receiving a request as to training instructions from the player terminal 40 in the nurturing function, the game computation unit 60 executes computation for a result of training indicating whether the training has succeeded or failed, and transmits the result of computation to the player terminal 40. Furthermore, for example, upon receiving a request as to a race entry in the nurturing function, the game computation unit 60 executes race competition simulation among a plurality of characters including the character serving as a nurturing object and non-player characters (NPC), and transmits the result of the race competition simulation to the player terminal 40. Furthermore, for example, upon receiving a request as to a race entry in the competition function, the game computation unit 60 executes race competition simulation among a plurality of characters including nurtured characters organized by the player and nurtured characters organized by the opponent, and transmits the result of the race competition simulation to the player terminal 40.

In addition, the game computation unit 60 includes a factor information decision unit 61. In the case where a character is nurtured in the nurturing function, the factor information decision unit 61 decides, by lottery, factor information to be tied to the nurtured character on the basis of the result of the nurturing.

The lottery for deciding factor information is drawn with reference to performance parameters, various kinds of aptitudes, and possessed skills of the character at the time the nurturing is ended, race entry history during nurturing, nurturing scenario, etc. For example, a blue factor is decided with reference to the performance parameters. In addition, for example, a red factor is decided with reference to various kinds of aptitudes. Furthermore, for example, a unique factor is decided with reference to the rarity of the character. Moreover, for example, skill factors are decided with reference to the possessed skills. In addition, for example, race factors are decided with reference to the race entry history during nurturing. Furthermore, for example, scenario factors are decided with reference to the nurturing scenario.

Thus, in this embodiment, with reference to the statuses, etc. of the character serving as a nurturing object in the nurturing function at the time the nurturing is ended, the factor information decision unit 61 decides factor information to be tied to the character for which nurturing has been completed.

In a lottery for deciding factor information for a character for which nurturing is completed, the factor information decision unit 61 executes a first process for deciding an earning object and a second process for deciding a factor level. In the first process related to the blue factor, any one of speed, stamina, power, spirit, and wisdom is selected as an earning object. In the first process related to the red factor, aptitudes with rank A or higher are extracted for the character for which nurturing is completed, and any one of the extracted aptitudes is selected as an earning object. In the first process related to the unique factor, on the basis of the rarity of the character for which nurturing is completed, a unique skill is decided as an earning object if the rarity is a predetermined stage or higher. In the first process related to the white factor, it is decided whether or not each of the white-factor candidates based on the possessed skills, race entry history, and selected scenario is won, so that the white factors that have been won are decided as earning objects. Also, regarding the items of factor information decided as earning objects in the first process, the factor information decision unit 61 decides, in the second process, a factor level of each of the items of factor information from level 1 to level 3. Note that, in this embodiment, the factor level is treated in the order of level 1<level 2<level 3, with level 3 being the highest and level 1 being the lowest.

In addition, upon request from the player terminal 40, the factor information decision unit 61 redraws a lottery for deciding factor information to be tied to the nurtured character. In this embodiment, although factor information is decided by lottery at the time character nurturing is ended in the nurturing function, the player can request to re-earn factor information at his/her discretion. In particular, in this embodiment, in the case where an input for requesting to re-earn factor information is made at the player terminal 40, the factor information decision unit 61, on the basis of the request for re-earning of factor information being received from the player terminal 40, redraws a lottery for deciding factor information to be tied to the character at the player terminal 40 under the same lottery conditions as those for the factor information reported to the player.

Furthermore, the game computation unit 60 includes a factor information application unit 62. In the course where a character is nurtured in the nurturing function, the factor information application unit 62 decides, by lottery, factor information that affects statuses of the character serving as a nurturing object, on the basis of the factor information tied to the inheritance characters.

Specifically, in a factor inheritance event that occurs in the course of proceeding with character nurturing in the nurturing function, the factor information application unit 62 draws a factor inheritance lottery based on the factor information of the inheritance characters. This embodiment is designed so that two inheritance characters are selected at the time a character is nurtured. More specifically, in the factor inheritance event, the factor information application unit 62 decides, by the factor inheritance lottery, whether or not to invoke each of the items of factor information tied to the inheritance characters and reinforces statuses of the character serving as a nurturing object on the basis of the invoked factor information. In this embodiment, in the case where it is decided that factor information is invoked, effects according to the kind of the factor information to be invoked are imparted to the character serving as a nurturing object. The effects include an increase in performance parameters, an increase in aptitude rank, enabled acquisition of a skill, etc.

Thus, in this embodiment, in the case where a character is nurtured in the nurturing function, the factor information application unit 62 can affect the statuses of the character serving as a nurturing object according to the factor information tied to a character that was nurtured in the past.

In addition, the game computation unit 60 includes a reward decision unit 63. In the case where the reward decision unit 63 receives a reward decision request transmitted from the player terminal 40, the reward decision unit 63 executes processing for deciding a reward to be provided by drawing a reward decision lottery. In this embodiment, in the case where the player transitions to the factor changing function in a state in which the event parameter satisfies the reward earning condition, a reward decision request is transmitted from the player terminal 40 to the server 20. Furthermore, in the case where it is decided that a reward decision lottery is drawn on the basis of reception of a reward decision request, the reward decision unit 63 sets reward IDs serving as objects to be decided by lottery from the difference data between the reward setting table and the reward earning data, extracts, from the objects to be decided by lottery, one reward ID to be provided, and reflects the extracted reward ID on the reward earning data. In addition, in this embodiment, the reward decided by a reward decision lottery is provided as a result of being added to the item list of the player who has earned the reward in the player management database 51.

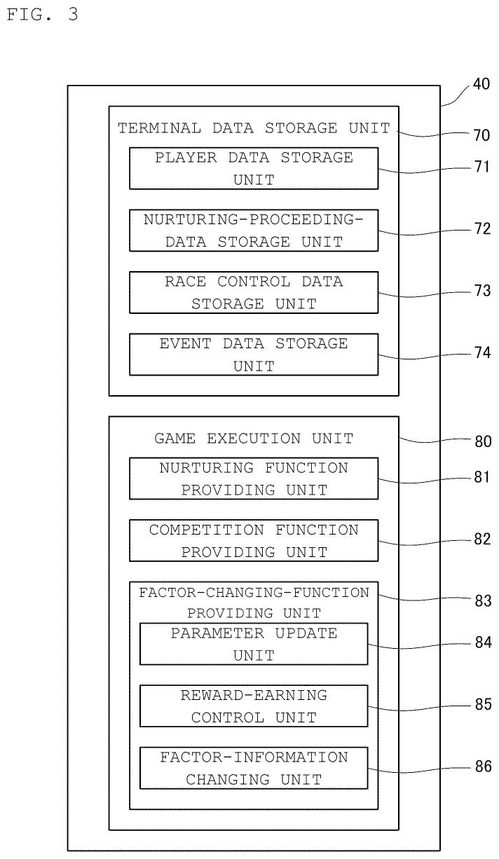

FIG. 3 is a functional block diagram showing main functions of the player terminal 40.

As shown in FIG. 3, the player terminal 40 in the information processing system 10 according to this embodiment realizes the nurturing function, the competition function, the factor changing function etc. through cooperative operation between a terminal data storage unit 70 and a game execution unit 80.

The terminal data storage unit 70 stores data required for the game execution unit 80 to execute various kinds of processing, and is realized mainly by the storage unit 42.

The terminal data storage unit 70 includes a player data storage unit 71, which stores, for example, data concerning the character list, nurturing object list, item list, and friend list corresponding to the player ID. In this embodiment, when the application is started and ended and in other situations as needed, the player data storage unit 71 of the player terminal 40 is synchronized with the player management database 51 of the server 20 with regard to data tied to the player ID (character list, nurturing object list, item list, friend list, etc.), so that various kinds of game processing are executed by using data stored in the player data storage unit 71. In this embodiment, in the case where the character list, the nurturing object list, the item list, or the friend list needs to be changed as a result of various kinds of game processing being executed, not only is the content stored in the player data storage unit 71 updated but also the stored content that has been updated is backed up to the player management database 51 of the server 20, whereby the content stored in the player data storage unit 71 is synchronized with the content stored in the player management database 51. Note that it is also acceptable to download, from the player management database 51 to the player data storage unit 71, the data tied to the player ID, such as the character list, the nurturing object list, the item list, and the friend list, as needed, such as when the application is started.

In addition, the terminal data storage unit 70 includes a nurturing-proceeding-data storage unit 72, which stores data needed to proceed with the nurturing function (nurturing-proceeding data) of a character that can be selected as a nurturing object in the nurturing function (character having a character type ID with which the information of “released” is associated in the nurturing object list). In this embodiment, nurturing goals, game events, etc. with regard to the nurturing function are prepared for each character, and nurturing-proceeding data, including at least content set as the nurturing goals and content set as the game events, is stored in the nurturing-proceeding-data storage unit 72 so as to be tied to the character type ID.

Also, the terminal data storage unit 70 includes a race control data storage unit 73, which stores: data that controls presentation, etc. of character motions and skill invocation when the player is allowed to watch a character entry race in the nurturing function and the competition function; and text data and audio data for live broadcasting of the race.

In addition, the terminal data storage unit 70 includes an event data storage unit 74, and the event data storage unit 74 stores various kinds of data for performing control related to the factor changing function. In this embodiment, the event data storage unit 74 stores data concerning a time period during which a factor-strengthening event is held that allows use of the factor changing function, data for managing the event parameter (an example of specific parameter) tied to the player ID, data for setting the amount of an increase in the event parameter, data for generating images related to a display screen and a dialog, data for managing the reward earning situation, etc.

The game execution unit 80 executes: processing for starting a game in the case where a game start condition is satisfied; processing for executing a game mode selected from a plurality of kinds of game modes; processing for proceeding with the game; processing for causing an event to occur in the case where an event occurrence condition is satisfied; processing for computing game results; processing for ending the game in the case where a game ending condition is satisfied; processing for requesting the server 20 to execute computation; processing for acquiring results of computation and necessary data from the server 20; processing for transmitting results of computation and data in the player terminal 40 to the server 20; etc. The game execution unit 80 is realized mainly by the control unit 41 and the communication unit 45. In this embodiment, the game execution unit 80 includes a nurturing function providing unit 81, a competition function providing unit 82, and a factor-changing-function providing unit 83.

The nurturing function providing unit 81 executes processing for providing the nurturing function for nurturing a character. In this embodiment, the nurturing function providing unit 81 accepts an input as to character nurturing, displays the result of computation in response to the input, etc.

In this embodiment, when a character is to be nurtured in the nurturing function, the player is required, in each turn, to select an action that is subjected to turn consumption. Actions that are subjected to turn consumption include training, entering in a race, going out, dispensary, etc. The nurturing function providing unit 81 accepts, through a nurturing home screen, etc. displayed on the display unit 44, the selection of an action that is subjected to turn consumption, and requests the server 20 to execute computation for a result of the selected action. Upon receiving the request, the server 20 executes computation for a result of the selected action and transmits the result of computation to the player terminal 40. The nurturing function providing unit 81 displays, on the display unit 44, a display screen corresponding to the result of computation received from the server 20.

In addition, in this embodiment, nurturing goals are set according to the type of the character serving as a nurturing object, and a predetermined turn may include a mandatory action that must be selected for a nurturing goal. Mandatory actions for a nurturing goal include, for example, entering in a predetermined race or winning a predetermined finish place in a predetermined race. In this case, in a turn in which a predetermined race associated with the nurturing goal is set, entering in the race is a mandatory action, thus prohibiting selection of a turn-consuming action other than entering in the race. Thus, in a turn in which selection of a mandatory action is accepted, the nurturing function providing unit 81 performs control for restricting the selection of an action different from the mandatory action.

Furthermore, the nurturing function providing unit 81 executes processing for acquiring, from the server 20, the factor information to be tied to the character for which nurturing has been completed, notifying the player of the acquired factor information, and then, through approval given by the player, registering the character to which the factor information is tied in the character list in the player management database 51 and the character list in the player data storage unit 71.

More specifically, the nurturing function providing unit 81 executes processing for acquiring, from the server 20, the factor information to be tied to the character for which nurturing has been completed and notifying the player of the acquired factor information. For example, on the basis of character nurturing being ended in the nurturing function, the nurturing function providing unit 81 transmits a factor earning request to the server 20 and acquires, from the server 20, factor information scheduled to be tied to the character. Then, the nurturing function providing unit 81 notifies, through the display unit 44, the player of the factor information acquired from the server 20.

In addition, after the player has been notified of the factor information, the nurturing function providing unit 81 executes processing for accepting an input for requesting to re-earn factor information and allowing a change in the factor information to be tied to the character for which nurturing has been completed.

More specifically, after the player has been notified of the factor information, the nurturing function providing unit 81 accepts an input for determining the factor information or an input for re-earning factor information, transmits a factor re-earning request to the server 20 on the basis of the acceptance of an input for re-earning factor information, and acquires, from the server 20, the factor information decided by a redrawn lottery. In the case where factor information is re-earned, the nurturing function providing unit 81 displays the factor information that has been earned earlier and the factor information that has been earned later with regard to the character for which nurturing has been completed so that the two items of factor information can be compared, thereby allowing the player to select which of the two items of factor information should be tied to the character. Then, the nurturing function providing unit 81 accepts selection as to which of the factor information that has been earned earlier and the factor information that has been earned later should be tied to the character and determines that the factor information corresponding to the result of selection is factor information to be tied to the character.

Furthermore, on the basis of the factor information to be tied to the character being determined, the nurturing function providing unit 81 registers the nurtured character in the character list in the player data storage unit 71 and transmits a character registration request to the server 20. Upon receiving the character registration request, the server 20 registers, in the character list in the player management database 51, the nurtured character corresponding to the character registration request.

The competition function providing unit 82 executes processing for providing the competition function in which a nurtured character possessed by the player is made to compete in a race with nurtured characters of other players and non-player characters (NPC).

In this embodiment, races that can be used by the player in the competition function include three kinds: team stadium, daily race, and daily legend race.

The team stadium is a competition function in which five teams are organized by selecting three characters from the nurtured characters possessed by the player for each of the five kinds of distance categories including short distance, mile, intermediate distance, long distance, and dirt to compete against the teams organized by another player in five kinds of races corresponding to the five kinds of distance categories. The team having the character who has won the first place in the race corresponding to each of the distance categories is declared a winner, and a team which has won three of the five kinds of races is regarded as having defeated the opponent. In the team stadium, stadium points are granted in each of the races according to the behavior and finish places of characters, and the ranking of the player is decided according to the total of stadium points in the five kinds of races, so that rewards are granted according to the ranking.

The daily race is a competition function in which races with different rewards and difficulty levels are prepared for the distance category of mile or intermediate distance, one of the nurtured characters possessed by the player is selected, and the selected nurtured character is made to enter in a race and compete against non-player characters (NPCs) in the race. In the daily race, a reward can be earned according to the finish place of the nurtured character in a race in which the character has been made to enter by the player.

The daily legend race is a competition function in which a character piece can be earned as a reward according to the result of a race. A character piece is an item that allows a character who is unreleased as a nurturing object to be released or the rarity of a released character to be raised by consuming a predetermined number of character pieces. In the daily legend race, a race condition is set for each character, a character for whom earning of a character piece is desired is selected, one of the nurtured characters possessed by the player is selected, and the selected nurtured character is made to enter in a race. Also, in the daily legend race, if the nurtured character who has been made to enter in a race by the player wins the first place in the race, the player can earn a character piece of the character corresponding to the race in which the nurtured character has been made to enter.

In the case where the player has decided to make a character enter in a race in each of the competition functions including the team stadium, the daily race, and the daily legend race, the competition function providing unit 82 transmits a competition result request to the server 20. In the server 20 that has received the competition result request from the player terminal 40, race competition simulation is executed, and the competition function providing unit 82 acquires a result of the race competition simulation from the server 20. In the player terminal 40 that has received the result of the race competition simulation from the server 20, the competition function providing unit 82 generates a race video based on the result of the race competition simulation on the basis of various kinds of data stored in the race control data storage unit 73 and displays the generated race video on the display unit 44, thus allowing the player to watch how the race proceeds.

The factor-changing-function providing unit 83 makes it possible to use the factor changing function that allows the player to change factor information tied to nurtured characters possessed by the player in a time period during which a factor-strengthening event is held. The factor-changing-function providing unit 83 includes a parameter update unit 84, a reward-earning control unit 85, and a factor-information changing unit 86.

The parameter update unit 84 executes processing for updating the event parameter in the case where the game function using a nurtured character is used. More specifically, the event parameter is updated in the case where a character is nurtured as a result of a nurtured character being used as an inheritance character by the nurturing function or in the case where a race in which a nurtured character has been made to enter is held by the competition function. The event parameter is updated when the nurturing of a character is ended in the case where the nurturing function is used, and the event parameter is updated when a race entry result is displayed in the case where the competition function is used.

In the case where the event parameter satisfies the reward earning condition, the reward-earning control unit 85 executes processing for allowing the earning of a factor-changing item that constitutes a right to change factor information. In this embodiment, in the case where an input for transitioning to the factor changing function is accepted in a time period during which a factor-strengthening event is held, the reward-earning control unit 85 determines whether or not the reward earning condition is satisfied on the basis of the event parameter. In the case where it is determined that the event parameter satisfies the reward earning condition, the reward-earning control unit 85 transmits a reward decision request to the server 20. In the server 20 that has received the reward decision request, a reward to be provided is decided by drawing a reward decision lottery. The reward-earning control unit 85 acquires, from the server 20, a reward ID for identifying a reward based on the result of the reward decision lottery and adds an item corresponding to the reward ID to the item list in the player data storage unit 71. In this embodiment, the player earns a factor-changing item in the case where a factor-changing item is won by a reward decision lottery. Note that control related to the earning of a reward (determination as to the reward earning condition, transmission of a reward decision request, acquisition of the result of a reward decision lottery, execution of presentation related to reward earning, etc.) may be performed not only in the case where an input for transitioning to the factor changing function is accepted but also in the case where the event parameter is updated while another game function, such as the nurturing function and the competition function, is used.

The factor-information changing unit 86 executes processing for allowing a change in factor information tied to a nurtured character by consuming a factor-changing item. In this embodiment, in response to the consumption of one factor-changing item, the factor level of any one of the blue factor, red factor, and unique factor of a nurtured character selected by the player can be raised by one stage. In this embodiment, raising of a factor level is realized by changing the factor ID. For example, in the case where the factor level of the factor name “speed”, which is a blue factor, is raised from level 1 to level 2, the factor level of “speed” can be raised by one stage by changing the factor ID corresponding to level 1 of “speed” to a factor ID corresponding to level 2 of “speed”.

Also, in this embodiment, factor information tied to a nurtured character can be classified as one of four factors: blue factor, red factor, unique factor, and white factor. Among the four factors, the factor levels of the blue factor, red factor, and unique factor can be raised by the factor changing function, whereas the factor level of the white factor cannot be raised by the factor changing function. In this manner, regarding the factor information to be tied to a nurtured character, the factor-information changing unit 86 performs control so as to allow a change in factor information concerning the blue factor, red factor, and unique factor and not to allow a change in factor information concerning the white factor.

Furthermore, in this embodiment, the factor level of factor information with the highest factor level of a nurtured character selected by the player, even if the factor information is classified as the blue factor, red factor, or unique factor, cannot be raised by the factor changing function. Thus, the factor-information changing unit 86 performs control so as not to allow a change in factor information satisfying a predetermined condition (e.g., having the highest factor level) even if the factor information is classified as the blue factor, red factor, or unique factor. That is, the factor-information changing unit 86 performs control so as not to allow a change in factor information not satisfying a change permission condition that the factor level is not highest, even if the factor information belongs to a predetermined category.

### 2. Control Method According to this Embodiment

A control method according to this embodiment will be described below in the context of an example where a game program according to this embodiment is applied as a game app for the player terminal 40 provided as a smartphone.

The game program according to this embodiment is configured so as to be capable of providing a plurality of kinds of game functions. In the nurturing function, which is a main game function, a character serving as a nurturing object is selected from a plurality of kinds of characters, statuses of the character change according to the proceeding of the game, and the statuses of the character are determined when a predetermined ending condition is satisfied, whereby the character nurturing is ended. A nurtured character has factor information according to the result of nurturing tied thereto, so that when the nurtured character is used as an inheritance character to nurture a new character, statuses of the character to be newly nurtured can be reinforced on the basis of the factor information tied to the inheritance character. In addition, in this embodiment, a quota for nurtured characters that can be possessed (number of characters that can be registered in the character list) is defined in advance, so that when the quota for possessed characters (e.g., 240) is filled, no new characters can be nurtured in the nurturing function. Because of this, it is necessary to delete a nurtured character from the character list to secure room in the quota for possessed characters. This embodiment newly proposes the factor changing function for allowing a change in factor information tied to a nurtured character nurtured by the nurturing function and, for this purpose, describes the outline of the nurturing function related to earning and use of factor information.

In the nurturing function, the player nurtures a character by selecting one character serving as a nurturing object from a plurality of kinds of characters at his/her discretion. Each of the plurality of kinds of characters that can be selected as nurturing objects has initial statuses set therein. In addition, each of the characters serving as nurturing objects acquires a unique skill (unique skill) according to the kind of the character from the start of nurturing. The conditions for invoking unique skills and the effects at the time those unique skills are invoked differ from one another. Furthermore, a plurality of kinds of characters that can be selected as nurturing objects have set therein growth correction rates of parameters, such as speed, stamina, power, spirit, and wisdom, according to the character, so that parameters that are readily increased are set for each of the kinds of characters.

When character nurturing is started after a nurturing object has been selected, the player can nurture a character by instructing nurturing in each of a maximum of 75 turns. Specifically, when the player instructs training associated with performance parameters, such as speed, stamina, power, spirit, and wisdom, performance parameters change and skill points are earned according to the result of training. Also, one turn can be consumed by instructing an entry in a race, so that performance parameters can change and skill points can be earned according to the result of the race. In addition, when an event occurrence condition is satisfied during nurturing, an event occurs, resulting in an increase in the number of kinds of acquirable skills and a change in performance parameters. Skill points as described above are points used to allow the character serving as a nurturing object to acquire a skill, so that the player can allow the character to acquire a skill from the list of acquirable skills by consuming possessed skill points.

Furthermore, in character nurturing, a plurality of nurturing goals are set for each character according to the kind of the character serving as a nurturing object. Examples of nurturing goals include entering in a target race, winning a predetermined or higher finish place in a target race, and earning a predetermined number of fans before a predetermined turn. In this embodiment, when the character being nurtured is made to enter in a race, the character can earn the number of fans according to the finish place, and race entry conditions based on the number of fans are specified according to the race.

Also, in this embodiment, a plurality of nurturing goals are set for each character in the turns up to the 72nd turn, whereas the 73rd to 75th turns constitute ending races. The ending races are held over the three turns constituting an elimination race, a semi-final race, and a final race, respectively. The player can give instructions as to nurturing before making the character enter in each of the three races.

Moreover, in this embodiment, in the case where a nurturing goal set in character nurturing is to win a finish place within a predetermined finish place in a target race, a continue function is available as a rescue function that is carried out when the character fails in winning a finish place within the specified finish place. This continue function is to give the player a chance to retry the target race, allowing the player to retry the target race by consuming the number of continue tokens that have been granted in advance. In this embodiment, the number of continue tokens is set to 3 through nurturing of one character.

Also, in a nurturing game function, the player can transition to a nurturing ending confirmation state as a result of any of the plurality of kinds of ending conditions defined in advance being satisfied.

First, in the case where the player reaches the final race, i.e., the 75th turn, of the ending races, the nurturing is ended as the final race ends. Note that in the case where the finish place is the second place or lower in the final race, the player can retry the final race as long as there is a remaining continue token. On the other hand, the nurturing is ended in the case where the finish place is the second place or lower in the final race after all continue tokens have been consumed. Note that it is up to the player whether or not to use the continue function, and in the case where the player selects not to use the continue function, the nurturing is ended at the time the selection is made.

The nurturing is also ended in the case where the player fails to achieve any of the nurturing goals set for each character in the turns up to the 72nd turn.

For example, in the case where a nurturing goal is to earn a predetermined number of fans, the nurturing is ended when the specified number of fans is not reached in a turn set in the nurturing goal. In this case, the player cannot use the continue function, and therefore, the nurturing is ended at the time the player reaches a turn subjected to a determination as to the nurturing goal because the predetermined number of fans is not reached.

In addition, for example, in the case where a nurturing goal is to enter in a target race, the nurturing goal is achieved as long as the character can enter in the target race, regardless of the finish place in the race. However, each race requires the player to have a predetermined number of fans, constituting a race entry condition, and in the case where the player fails to have the number of fans, constituting a race entry condition, in the turn corresponding to the target race, the nurturing is ended because the character cannot enter in the target race.

Furthermore, for example, in the case where a nurturing goal is to win a finish place within a predetermined finish place in a target race, the nurturing is ended when the race entry condition for the target race is not satisfied. Even though the character enters in the target race, the nurturing is also ended in the case where the character fails to win a finish place within the predetermined finish place and there is not a remaining continue token. As described above, it is up to the player whether or not to select the use of the continue function. In the case where the player selects not to use the continue function despite a remaining continue token, the nurturing is ended as a result of the nurturing goal not being achieved.

Furthermore, in the case where the player is in the 73rd turn or after, the player can proceed to the subsequent turn by winning the first place in each of the elimination race and the semi-final race of the ending races, and the nurturing is ended in the case where the player's finish place is the second place or lower and there are no remaining continue tokens. Also in this case, if the player selects not to use the continue function, the nurturing is ended at that time.

In this embodiment, the player transitions to the nurturing ending confirmation state when a nurturing ending condition is satisfied. This nurturing ending confirmation state gives the player the last chance to acquire a skill before the statuses are determined, so that the player can acquire a skill by consuming skill points possessed at that time. Furthermore, an input interface for allowing the player to make an input for confirming that the nurturing is ended is prepared in the nurturing ending confirmation state, and factor information is decided when the player makes an input for confirming that the nurturing is ended. In this embodiment, when the player is notified of the decided factor information, the player can request to re-earn factor information at his/her discretion, so that the player can select which of the factor information that has been earned earlier and the re-earned factor information should be tied to the current nurtured character. When factor information to be tied to the character for which nurturing has been completed is determined, the statuses of the character serving as a nurturing object are determined, and information concerning that character is registered as a nurtured character in the character list in the player data storage unit 71 and the character list in the player management database 51.

When the statuses of the character serving as a nurturing object are determined via the nurturing ending confirmation state, rewards according to the result of nurturing are provided. In this embodiment, in-game currency, strengthening points, etc. according to the total numbers of fans earned until the end of nurturing are provided as rewards.

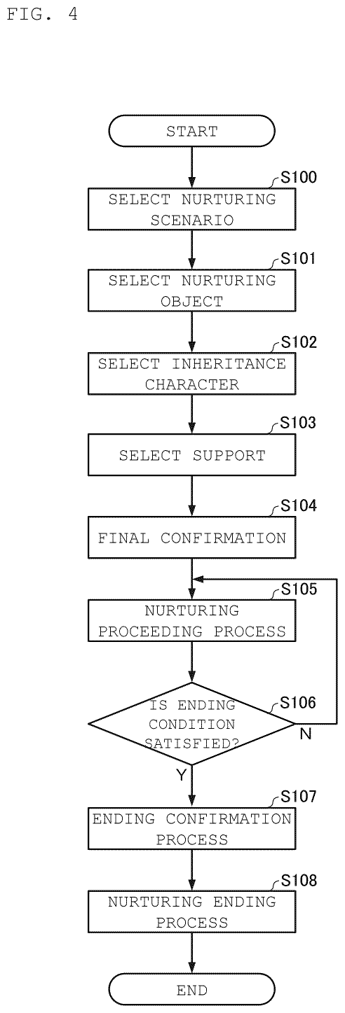

In the following, game proceeding in the nurturing function for nurturing a character will be described in more detail with reference to FIG. 4.

Selection of a nurturing scenario is accepted before character nurturing is started (step S100). In this embodiment, a plurality of kinds of nurturing scenarios are prepared, and how performance parameters are increased and how skills are acquired differ depending on the selected nurturing scenario. A nurturing scenario to be selected can be switched via a swipe input, and when an input for deciding a nurturing scenario (e.g., tap input to a decision button) is performed, selection of a character serving as a nurturing object is accepted with the selected nurturing scenario (step S101).

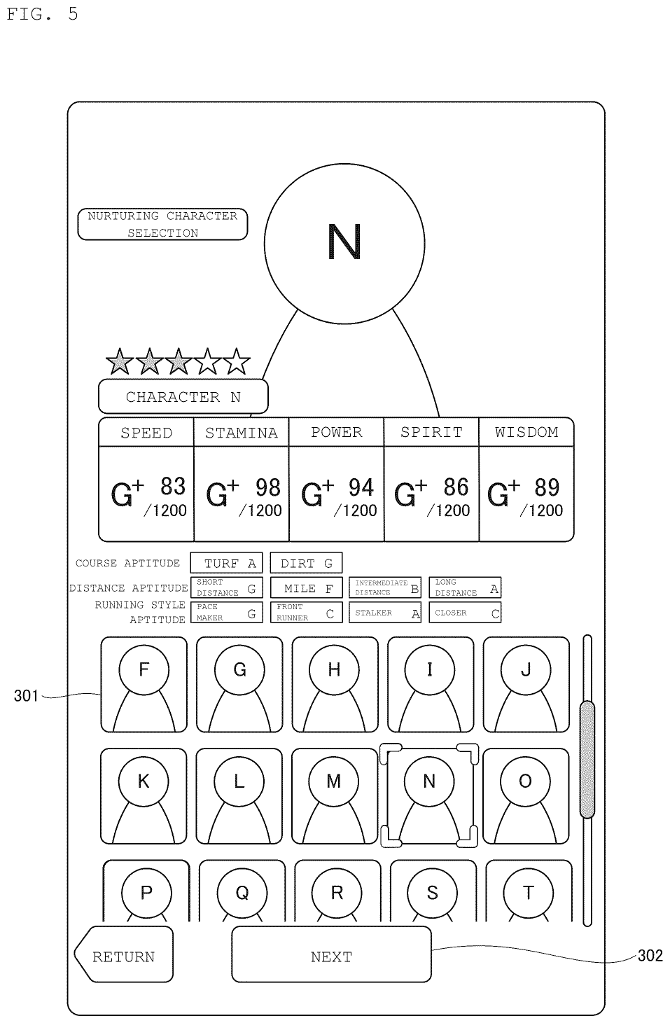

In this embodiment, as shown in FIG. 5, a nurturing object can be selected by tapping a character icon 301 for identifying a character on a nurturing-character selection screen. Information concerning characters selectable as nurturing objects (nurturable characters) is managed in the nurturing object list in the player data storage unit 71, and the nurturing-character selection screen is displayed by acquiring the character type IDs of the nurturable characters from the nurturing object list. On the nurturing-character selection screen, the player can confirm information concerning the initial statuses of the character being selected. In this embodiment, initial statuses the player can confirm on the nurturing-character selection screen include information concerning: performance parameters (speed, stamina, power, spirit, and wisdom); course aptitudes (turf track and dirt track); distance aptitudes (short distance, mile, intermediate-distance, and long distance); and running style aptitudes (pace maker, front runner, stalker, and closer).

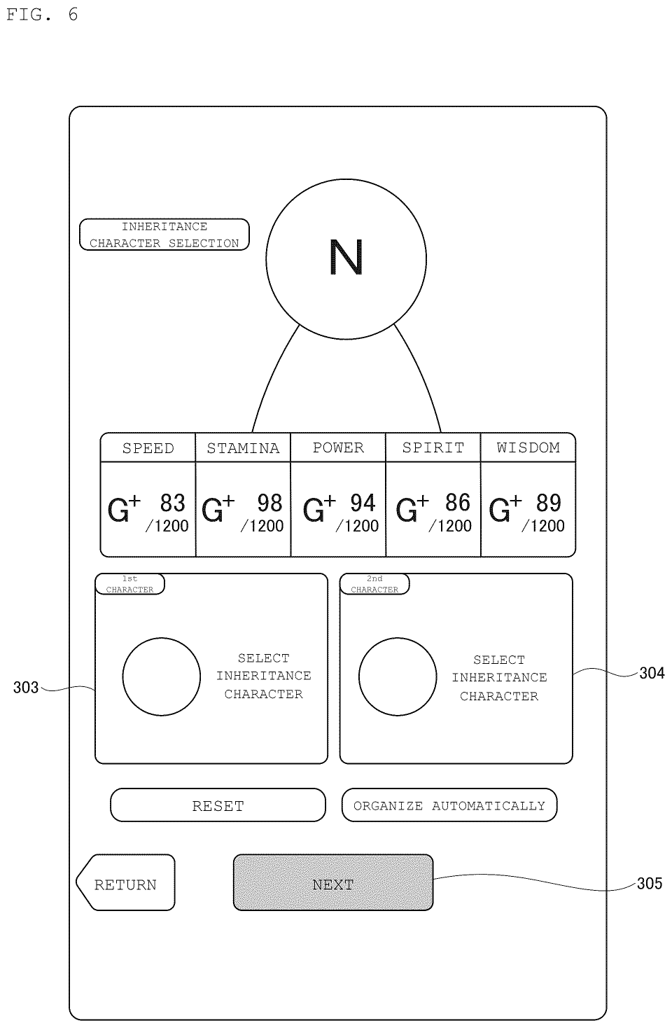

When a tap input is made to a proceeding button 302 on the nurturing-character selection screen shown in FIG. 5 while the character icon 301 of a character serving as a nurturing object is selected, the display screen transitions to an inheritance-character selection screen, as shown in FIG. 6, thereby accepting the selection of an inheritance character (step S102).

This embodiment is designed so that the player can select, as inheritance characters for new nurturing, two nurtured characters that were nurtured in the past and reinforce statuses of the character to be nurtured on the basis of the factor information tied to the two selected inheritance characters (information earned by the inheritance characters when they were nurtured).

In this embodiment, statuses of the character serving as a nurturing object are reinforced on the basis of factor information in a factor inheritance event that occurs when nurturing is started and when predetermined turns are reached after nurturing has been started. In the case where a factor inheritance event occurs during character nurturing in the nurturing function, an event result request is transmitted from the player terminal 40 to the server 20. In the server 20 that has received the event result request, a factor inheritance lottery is drawn on the basis of the factor information tied to the two inheritance characters, and a lottery result is transmitted to the player terminal 40. In the player terminal 40 that has received the lottery result, statuses of the character serving as a nurturing object are reinforced, such as an increase in performance parameters and an increase in the skill acquisition level, on the basis of the lottery result, and a display process for notifying the player of results of statuses reinforced by the factor inheritance event is executed.

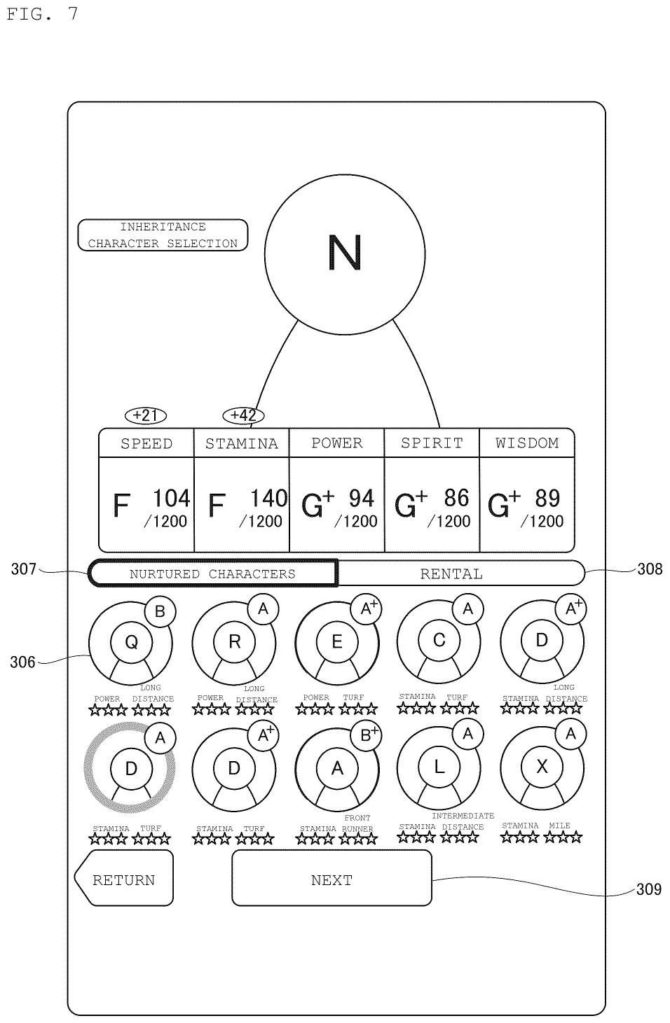

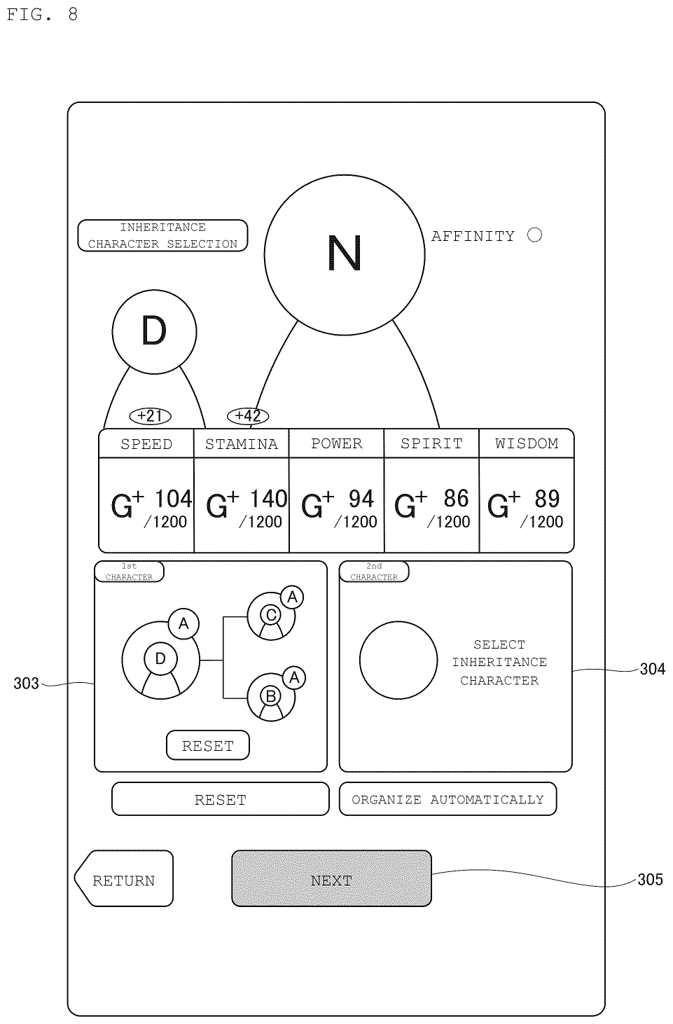

When selecting inheritance characters, the player makes a tap input to one of an inheritance frame 303 and an inheritance frame 304 for two characters, thereby displaying a list of selectable inheritance characters. When a tap input is made to the inheritance frame 303 (or the inheritance frame 304) on the inheritance-character selection screen shown in FIG. 6, an inheritance-character list screen is generated and displayed with reference to the character list in the player data storage unit 71 and the list of nurtured characters (inheritance character list), as shown in FIG. 7. On the inheritance-character list screen, a character can be selected by making a tap input to a character icon 306, and when a tap input is made to a proceeding button 309 while any of the inheritance characters is selected, the display screen returns to the inheritance-character selection screen, as shown in FIG. 8.

In addition, when selecting an inheritance character, the player can not only select a nurtured character nurtured by the player himself/herself but also rent and use a nurtured character nurtured by another character registered by the player as a friend. In this embodiment, a nurtured character nurtured by another character can be rented up to three times per day. On the inheritance-character list screen shown in FIG. 7, a nurtured character tab 307 and a rental tab 308 are provided, and when a tap input is made to the rental tab 308, a rental character acquisition request is transmitted to the server 20. Upon receiving the rental character acquisition request, the server 20 refers to friend registration information (profile information of other players registered as friends) tied to the player ID that has transmitted the rental character acquisition request and transmits, to the player terminal 40, the list of rental characters (rental character list) set in the profile information by the other players registered as friends. Also, at the player terminal 40, an inheritance-character list screen is generated and displayed on the basis of the received rental character list.

In addition, it is necessary to select two inheritance characters in order to start character nurturing, and a proceeding button 305 appears grayed out in a state in which only one inheritance character is selected, as shown in FIG. 8, thereby prohibiting proceeding with preparations for starting character nurturing.

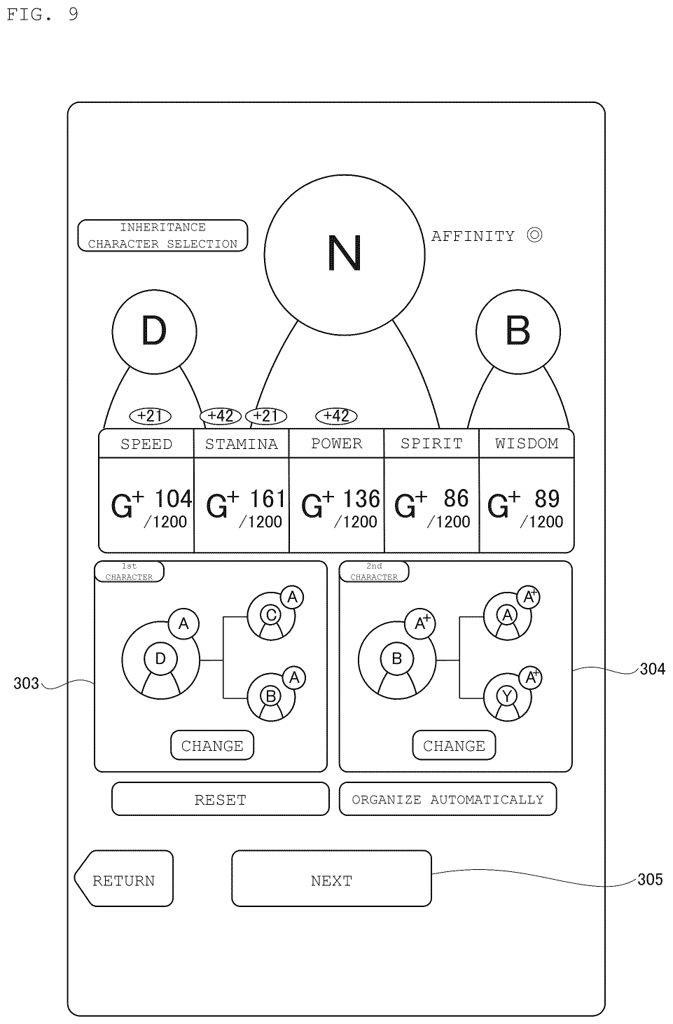

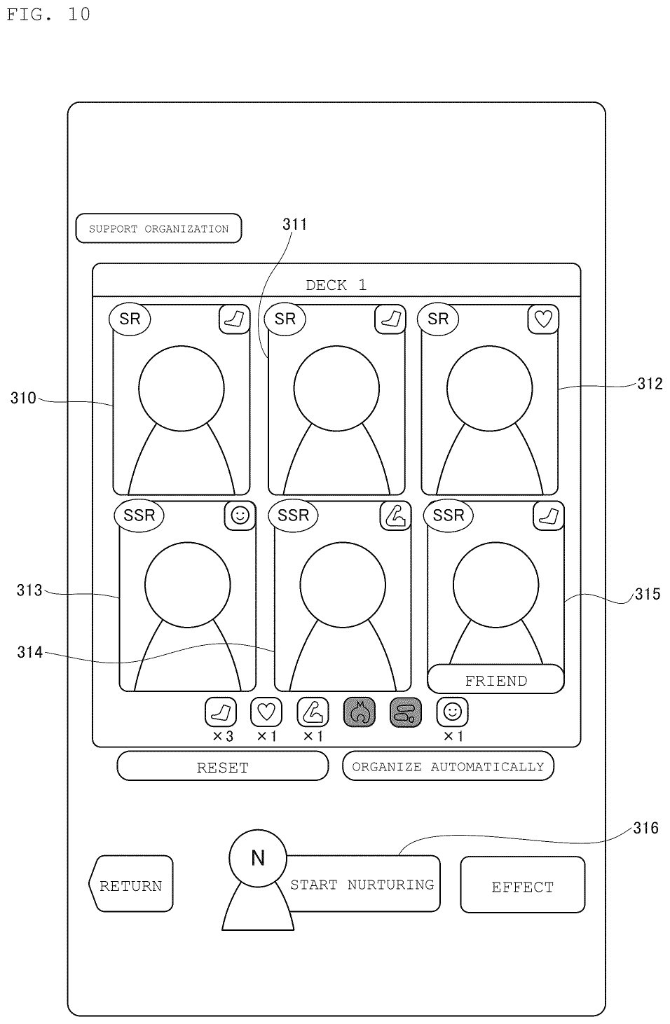

As shown in FIG. 9, when a tap input is made to the proceeding button 305 on the inheritance-character selection screen while two inheritance characters are selected, the display screen transitions to a support organization screen, as shown in FIG. 10, thus accepting selection of a support item (step S103).

In this embodiment, a support item simulating a card is available as an item for supporting character nurturing, and a support item allows the player to bring about the effect of increasing performance parameters and increase the number of kinds of acquirable skills. When a character is to be nurtured, it is necessary to organize six support items. Note that five of the six support items are selected from the support items possessed by the player himself/herself, and the remaining one support item, for a friend frame, is rented from support items possessed by other players.

Support items are classified, according to the performance thereof, into six categories: speed, stamina, power, spirit, wisdom, and friend. The support items of speed, stamina, power, spirit, and wisdom literally bring about the effect of increasing parameters corresponding to the performance parameters of the character at the time of training, and the support item of friend brings about the effect of recovering the physical strength and motivation. The category of a support item is identifiable by a category icon, and the player selects six support items used for this round of nurturing by drawing on the category icon. In addition, a support item has three stages of rarities: rare (R), super rare (SR), and special super rare (SSR). In this embodiment, the rarity becomes higher in the order of R<SR<SSR, and basically, the higher the rarity, the more profound the support effect.

As shown in FIG. 10, player support frames 310 to 314 for five support items and a friend support frame 315 for one support item are provided on the support organization screen. When a tap input is made to any of the player support frames 310 to 314, a list of support items (player support list) is acquired with reference to the item list in the player data storage unit 71. Also, a screen for displaying the list of support items possessed by the player is generated on the basis of the acquired player support list, thereby accepting selection of a support item. In addition, when a tap input is made to the friend support frame 315, a friend support acquisition request is transmitted to the server 20. Upon receiving the friend support acquisition request, the server 20 refers to the friend registration information tied to the player ID that has transmitted the friend support acquisition request and transmits, to the player terminal 40, a list of support items (friend support list) set in the profile information by other players registered as friends. In the player terminal 40, a screen for displaying a list of support items that can be set in the friend support frame 315 is generated on the basis of the received friend support list, thereby accepting selection of a support item.

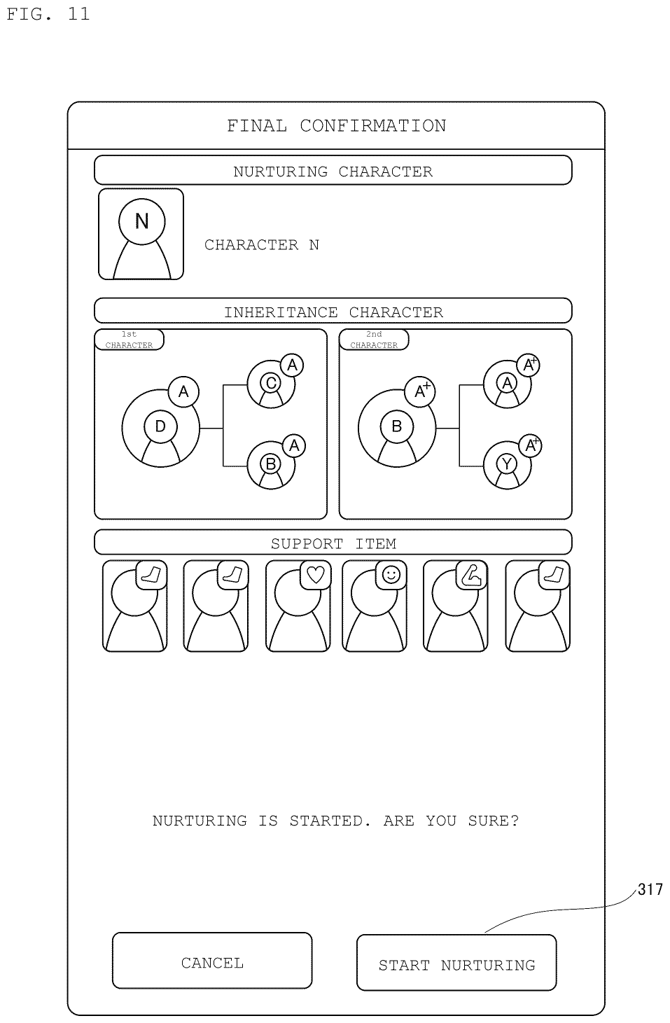

As shown in FIG. 10, when a tap input is made to a nurturing start button 316 while six support items are organized on the support organization screen, the display screen transitions to a final confirmation screen, as shown in FIG. 11, thus accepting the player's input for confirming start of nurturing (step S104). On the final confirmation screen, the character serving as a nurturing object, the inheritance characters, and the organized support items that have been selected by the player are displayed.

Also, when a tap input is made to a nurturing start button 317 on the final confirmation screen, a nurturing proceeding process for nurturing the character is executed (step S105). Note that, in this embodiment, when a tap input is made to the nurturing start button 317 on the final confirmation screen in a preparatory stage at the time nurturing is started, the character serving as a nurturing object is set as a default character. Through this setting of a default character, the default character can be set as an initially selected character on the nurturing-character selection screen when the next round of nurturing is to be executed. This is convenient to a player who repeatedly nurtures the same character. In addition, in this embodiment, it is necessary to consume trainer points (TP) possessed by the player in order to nurture a character in the nurturing function. Trainer points are recovered over time by a predetermined amount at a time, and can also be recovered by using a recovery item.

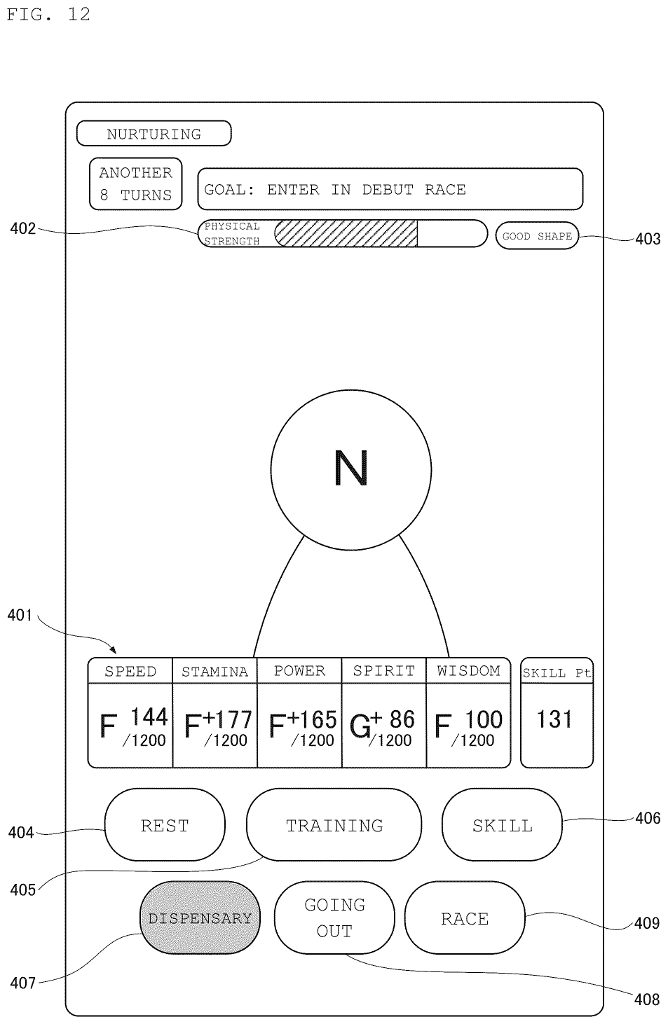

FIG. 12 shows an example of the nurturing home screen, which is a kind of display screen during character nurturing.

In the character nurturing function according to this embodiment, the display screen transitions basically from the nurturing home screen to a screen for instructing various kinds of actions, such as training. On the nurturing home screen, not only is the character serving as a nurturing object displayed in the form of animation but also a status indication field 401 is provided to display the current statuses of the character (speed, stamina, power, spirit, wisdom, and skill points).

Also, on the nurturing home screen, a physical strength gauge 402 and a motivation icon 403 are displayed. The physical strength gauge 402 is a gauge indicating the physical strength, which is a parameter that affects the failure rate of training, and varies with training or a race entry during nurturing, a game event that occurs during nurturing, etc. As the physical strength decreases, training is more likely to fail and the motivation decreases. In addition, the motivation icon 403 represents motivation, which is a parameter indicating physical condition of the character being nurtured, and, in this embodiment, is set to any of the five stages: very bad shape; bad shape; normal; good shape; and great shape. This parameter referred to as motivation affects training effects and performance parameters of the character when entering in a race. Training effects and performance parameters of the character when entering in a race are corrected to decrease in the case of “very bad shape” and “bad shape” than in the case of “normal”, and are corrected to increase in the case of “good shape” and “great shape” than in the case of “normal”.

Furthermore, on the nurturing home screen, buttons for selecting various kinds of actions, such as training, are provided, including a rest button 404, a training button 405, a skill button 406, a dispensary button 407, a going-out button 408, and a race button 409. In this embodiment, the player in principle is allowed to give instructions as to one kind of action (more specifically, any one kind of the rest, training, dispensary, going out, and race) in each turn, and when processing of the action corresponding to the instructions given in the current turn is completed, the current turn is consumed, advancing the game to the subsequent turn. Note that, in this embodiment, acquisition of a skill is an exception and does not involve consumption of a turn. In this embodiment, as described above, five kinds of actions including rest, training, dispensary, going out, and race are set as an action that consumes one turn in the nurturing function, and these actions may be referred to as turn consumption actions, as needed.

The rest button 404 is a button used to instruct the execution of rest for recovering the physical strength, and when a tap input is made to the rest button 404, a rest confirmation dialog box for confirming that the execution of rest is instructed is displayed. Subsequently, when a tap input is made to a decision button in the rest confirmation dialog box, a rest result request is transmitted to the server 20. In the server 20 that has received the rest result request, computation related to the amount of recovery in the physical strength and whether or not to cause a game event to occur is executed, and a rest result response including the result of computation is transmitted to the player terminal 40. In the player terminal 40 that has received the rest result response, an animation for recovering the physical strength gauge 402 is displayed on the basis of the result of computation included in the rest result response, and in the case where a game event occurs, processing related to the game event is executed.

The training button 405 is a button used to instruct training for varying performance parameters of the character, and when a tap input is made to the training button 405, the display screen transitions to a training screen (not shown in the figure). On the training screen, training related to each of the performance parameters including speed, stamina, power, spirit, and wisdom can be instructed. In this embodiment, speed and power increase in the case where speed training is executed; stamina and spirit increase in the case where stamina training is executed; power and stamina increase in the case where power training is executed; spirit, power, and speed increase in the case where spirit training is executed; and wisdom and speed increase in the case where wisdom training is executed. Skill points can also be earned in the case where any kind of training is executed.

In this embodiment, support items organized before the start of nurturing are randomly associated with training in each turn by lottery drawn by the server 20, so that in a training course associated with a support item, performance parameters are increased more greatly and a larger amount of skill points are earned due to the effect of the support item when training is executed.

In the case where training is executed, the physical strength is consumed. The physical strength can be confirmed with the physical strength gauge 402 on the nurturing home screen. The physical strength is a parameter affecting the failure rate in training, and the failure rate is likely to increase as the physical strength decreases. In this embodiment, in the case where training is instructed, the server 20 decides whether or not training has failed by drawing a lottery based on the failure rate. In the case where the training does not fail (training succeeds), the performance parameters corresponding to the training instructions are increased, and in the case where the training fails, the performance parameters do not increase and the physical strength is consumed.

When an input for an action instruction as to any training course is made via the training screen, a training result request is transmitted to the server 20. In the server 20 that has received the training result request, computation related to a result of the training and whether or not to cause a game event to occur is executed, and a training result response including the result of computation is transmitted to the player terminal 40. In the player terminal 40 that has received the training result response, a display process related to the result of training (display related to whether training has succeeded or failed and display for varying performance parameters) is executed on the basis of the result of computation included in the training result response, and in the case where a game event occurs, processing related to the game event is executed.

The skill button 406 is a button for allowing the character to acquire a skill, and when a tap input is made to the skill button 406, a skill acquisition screen indicating a list of skills that can be acquired by the character at that time is displayed. When a tap input is made to an acquisition button with a skill being selected on the skill acquisition screen, a skill acquisition request is transmitted to the server 20. In the server 20 that has received the skill acquisition request, the skill specified with the skill acquisition request is registered as an acquired skill in status information of the character being nurtured, and a skill acquisition completion response is transmitted to the player terminal 40. In the player terminal 40 that has received the skill acquisition completion response, processing for displaying that skill acquisition has been completed and displaying the skill acquired on the skill acquisition screen as an acquired skill is executed.

The dispensary button 407 is a button used to eliminate a bad status imparted to the character being nurtured, and an input is accepted only in the case where a bad status is imparted due to a game event during nurturing. In this embodiment, a bad status, such as lack of sleep, may be imparted as a result of a game event occurring. When a bad status is imparted, a game event disadvantageous for nurturing, such as the physical strength being more likely to decrease and the motivation being more likely to decrease, is more likely to occur. The dispensary button 407 appears grayed out in the case where no bad statuses are imparted to the character being nurtured. On the other hand, the dispensary button 407 is displayed normally and accepts a tap input in the case where a bad status is imparted to the character being nurtured. In the case where the elimination of a bad status is instructed by using the dispensary button 407, a dispensary result request is transmitted to the server 20. In the server 20 that has received the dispensary result request, a lottery is drawn to decide whether or not the bad status has been eliminated, and a dispensary result response including the content of the decision is transmitted to the player terminal 40. In the player terminal 40 that has received the dispensary result response, in the case where the bad status is eliminated, processing for informing the player that the bad status has been eliminated and eliminating the bad status from the status indication of the character is executed.

The going-out button 408 is a button used to increase the motivation of the character being nurtured. When a tap input is made to the going-out button 408, a going-out confirmation dialog box for confirming that going out is instructed is displayed. Subsequently, when a tap input is made to the decision button in the going-out confirmation dialog box, a going-out result request is transmitted to the server 20. In the server 20 that has received the going-out result request, a lottery related to a motivation increase event is drawn, and a going-out result response including information concerning the motivation increase event decided by the lottery is transmitted to the player terminal 40. In the player terminal 40 that has received the going-out result response, processing related to the motivation increase event is executed on the basis of the information included in the going-out result response.

The race button 409 is a button used to cause the character being nurtured to enter in a race. When a tap input is made to the race button 409, the display screen transitions to a race list screen (not shown in the figure) showing a list of races held in the current turn.

On the race list screen, the player can select a race in which the character being nurtured is made to enter. Also, on the race screen, race condition information of the race being selected, such as season (spring, summer, autumn, and winter), weather (shine, cloudy, rain, and snow), course state (firm, good, yielding, heavy), the number of race entry characters, and race-held turn, is displayed. In addition, each of the races has race entry conditions defined therein according to the number of fans earned by the character being nurtured. In the case of a race the race entry conditions of which are not satisfied by the character being nurtured, the character being nurtured is prohibited from entering in the race.

Furthermore, in this embodiment, a target race is set as a nurturing goal in some cases. In a turn in which a target race is set, no actions other than entering in a race are possible as a turn consumption action. In the case where a target race is set as a nurturing goal, the game is controlled so that only the target race can be selected on the race list screen.

When an input for deciding to enter in a race is made on the race list screen, a race entry request is transmitted to the server 20. In the server 20 that has received the race entry request, race competition simulation is executed for the entry race among the character being nurtured and NPCs (non-player characters), and a race result response including the result of the race competition simulation is transmitted to the player terminal 40. In the player terminal 40 that has received the race result response, a display process for allowing the player to watch how the race proceeds on the basis of the result of the race competition simulation is executed.

In this embodiment, in the case where the character being nurtured is made to enter in a race, performance parameters are adjusted according to the stage of the motivation in the turn in which the race entry is instructed, so that performance parameters are corrected to decrease in the case where the motivation is very bad shape or bad shape than in the case where the motivation is normal and so that performance parameters are corrected to increase in the case where the motivation is good shape or great shape than in the case where the motivation is normal.

In character nurturing, it is determined in a turn in which a nurturing goal is set whether or not the nurturing goal has been achieved. In the case where the nurturing goal is achieved, the player is notified that the nurturing goal has been achieved.

In this embodiment, the nurturing goals are set in turns up to the 72nd turn, and the number of nurturing goals and content of the nurturing goals are set individually according to the character type. Also, when all nurturing goals are achieved for the character being nurtured, the player can proceed to the ending races in the 73rd and subsequent turns.

For example, when the final nurturing goal set for the character being nurtured is achieved, the player is notified that achievement of all nurturing goals has been completed. In the case where all nurturing goals have been achieved in character nurturing, the 73rd and subsequent turns are processed such that the character is first made to enter in the elimination race, enter in the semi-final race after he/she has won the first place in the elimination race, and enter in the final race after he/she has won the first place in the semi-final race. When winning the first place in the final race, the character is regarded as the champion in the ending races, thus ending the nurturing. The player can also instruct the nurturing of the character before the character enters in each of the elimination race, semi-final race, final race in the respective turns. The 73rd and subsequent turns for the ending races are extra turns having no nurturing goals set therein. In the case where the player fails to win the first place in the elimination race or the semi-final race, he/she can retry those races by using the continue function, as long as there is a remaining continue token. In the case where there are no remaining continue tokens, the nurturing is ended. As described above, it is up to the player whether or not to select to use the continue function. Thus, in the case where the player selects not to use the continue function despite the fact that he/she can use it, he/she is regarded as losing the ending races at that time, thus ending the nurturing.

In addition, in the case where the player fails to achieve a nurturing goal set for the character being nurtured, the nurturing is ended at that time. In particular, in this embodiment, in the case where a nurturing goal is to win a finish place within a predetermined finish place in a target race, the player can retry the target race by using the continue function even if he/she fails to win a finish place within the predetermined finish place. In the case where nurturing goals are to earn a predetermined number of fans before a predetermined turn and enter in a target race, the player cannot use the continue function when he/she fails to achieve the nurturing goals, thus ending the nurturing in a turn subjected to a determination as to the nurturing goals.

Also, when a nurturing ending condition is satisfied in the nurturing proceeding process (Y in step S106), an ending confirmation process is executed (step S107). In the ending confirmation process, an ending confirmation screen that allows the player to confirm the statuses of the character serving as a nurturing object is displayed. A skill acquisition button and a nurturing ending button are provided on the ending confirmation screen. When a tap input is made to the skill acquisition button, a list of acquirable skills is displayed to allow the player to acquire skills within the range of possessed skill points. When a tap input is made to the nurturing ending button, a nurturing ending process is executed (step S108).

In the nurturing ending process, the statuses of the nurtured character are determined, and the nurtured character is registered. To determine the statuses of the nurtured character, evaluation scores are calculated, and factor information is decided. Registration of the nurtured character is completed by saving the statuses in the character list in the player data storage unit 71 so as to tie the statuses to the character individual ID. Evaluation scores are calculated on the basis of the performance parameters and acquired skills of the character, and factor information is decided by lottery.

Factor information is decided with reference to content (race entry history, etc.) in nurturing of the character and the statuses (performance parameters, acquired skills, etc.) at the time nurturing is ended. In addition, of the factor information, the blue factor and the red factor can always be earned, and the unique factor can be earned in the case where a talent-blooming level (level 1 to level 5), which indicates the rarity of the character serving as a nurturing object, is a predetermined level or higher (level 3 or higher). In addition, regarding the white factor of factor information, skill factors are decided with reference to the acquired skills, race factors are decided with reference to the races in which the character entered and won the first place during nurturing, and scenario factors are decided with reference to the nurturing scenario selected before the start of nurturing. Furthermore, when factor information to be tied to the character is to be decided, the factor level of the factor information decided as an earning object is decided by lottery. In this embodiment, three levels from level 1 to level 3 are prepared as the factor level, and any one of level 1 to level 3 is decided by lottery.

In addition, in the nurturing ending process, rewards for the result of nurturing are provided. In this embodiment, rewards are provided by adding them to the item list in the player data storage unit 71, and in-game currency and support points according to the number of fans earned during nurturing are decided as rewards. The larger the number of fans, the larger the amount of in-game currency and support points that can be earned.

Moreover, in the nurturing ending process, a nurturing ending request is transmitted to the server 20. In the server 20 that has received the nurturing ending request, the nurtured character is registered in the character list in the player management database 51, and rewards for the result of nurturing are added to the item list in the player management database 51.

Thus, in this embodiment, factor information is tied to the nurtured character as a result of the character being nurtured in the nurturing function. Also, the factor information tied to the nurtured character serves as factor information tied to an inheritance character when a new character is to be nurtured and is used to reinforce statuses of the character serving as a nurturing object. Because of this, in the case where the player fails to earn desired factor information after having nurtured a character in the nurturing function, he/she needs to nurture a character again.

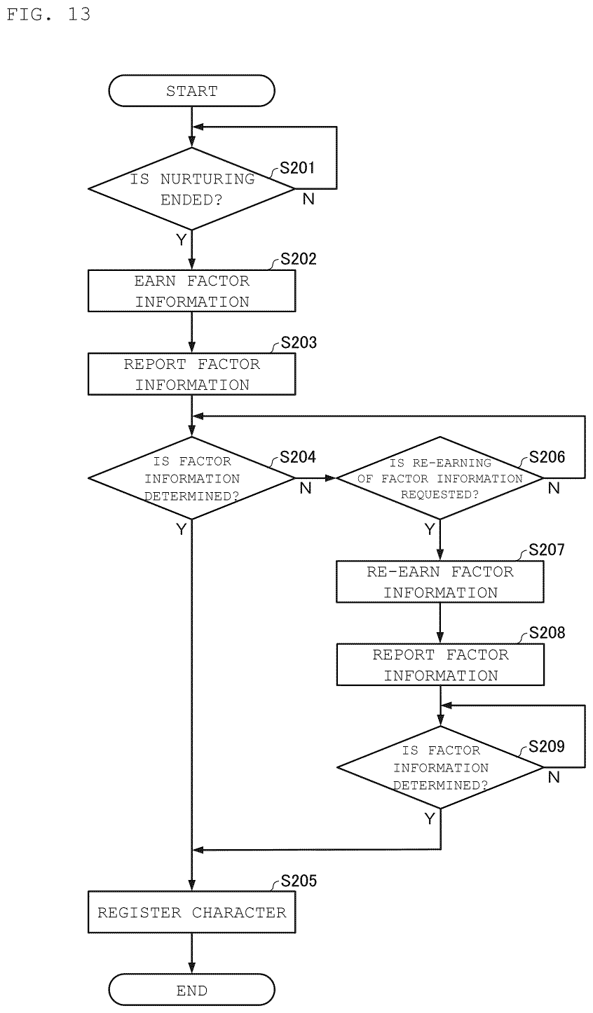

Given this situation, the present embodiment employs a mechanism in which after the player has been notified of factor information decided according to the result of character nurturing, he/she can request to re-earn factor information at his/her discretion. In the following, the flow of processing related to decision of factor information will be described with reference to the flowchart shown in FIG. 13.

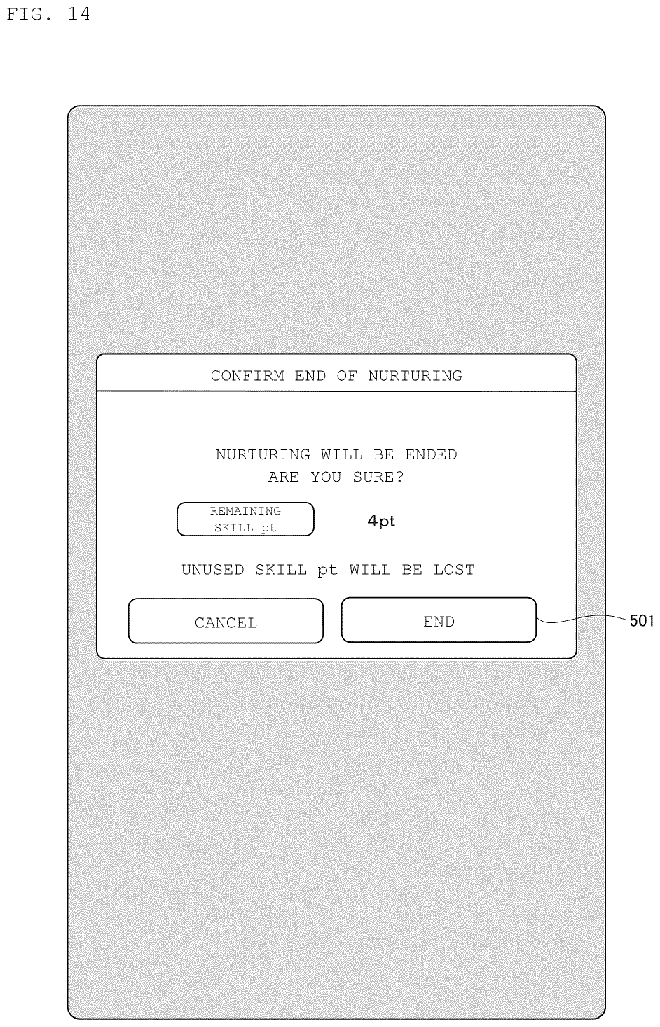

First, factor information is earned (step S202) on the basis of character nurturing being ended (Y in step S201). In this embodiment, a final confirmation dialog shown in FIG. 14 is displayed when the character nurturing is ended, allowing the player to give final confirmation. When a tap input is made to an end button 501 in a state in which the final confirmation dialog is displayed, performance parameters, various kinds of aptitudes, possessed skills, etc. are determined with regard to the statuses of the character serving as a nurturing object, and a factor earning request is transmitted from the player terminal 40 to the server 20. In the server 20 that has received the factor earning request, a lottery for deciding factor information is drawn on the basis of the factor earning request, and the lottery result is transmitted to the player terminal 40.

In the lottery for deciding factor information, a first process for deciding an earning object and a second process for deciding a factor level are executed for each of the blue factor, red factor, unique factor, and white factor in the format corresponding to the factor type, thus deciding factor information.

First, regarding the blue factor, a lottery is drawn in the first process to select one of the five kinds of performance parameters: speed; stamina; power; spirit; and wisdom. In this embodiment, each of the performance parameters is selected at a chance of 1/5, i.e., the performance parameters have the same chance of being selected. When one kind of performance parameter serving as an earning object is decided, a lottery is drawn in the second process to decide any one of the factor levels from level 1 to level 3. The factor level of a blue factor is decided by lottery with reference to the value of the performance parameter at the time character nurturing is ended. The higher the value of the performance parameter serving as an earning object in the first process, the more likely a high factor level is to be selected in the second process. In addition, in order that level 3 is selected for the factor level of a blue factor, the value of the performance parameter needs to exceed a predetermined level (e.g., 600 or more).

Next, regarding the red factor, the first process is executed so that aptitudes with an aptitude rank A or higher at the time character nurturing is ended are extracted, and a lottery is then drawn to select any one kind of the extracted aptitudes as an earning object. For example, with the aptitudes of a character N as shown in FIG. 5, three kinds of aptitudes: the course aptitude “turf track”; the distance aptitude “long-distance”; and the running style aptitude “stalker” are extracted as aptitudes with an aptitude rank of A or higher, and any one of the three kinds is decided by lottery at an equal selection probability (1/3). In this embodiment, the aptitude rank of an aptitude of the character serving as a nurturing object may be increased by means of a factor inheritance event as a result of being affected by information concerning the red factor of an inheritance character. For this reason, when the character serving as a nurturing object has an increased number of aptitudes with an aptitude rank A or higher due to a factor inheritance event, the number of aptitudes to be decided by lottery in the first process also increases.

Note that, in the first process related to the red factor, with reference to information concerning the red factors tied to the two inheritance characters selected before the start of nurturing the character serving as a nurturing object, the selection probability may be corrected to increase according to the kind of the red factor tied to each of the inheritance characters. For example, in the case where the red factors tied to the two inheritance characters relate to the course aptitude and the distance aptitude, selection probabilities of the course aptitude and the distance aptitude can be corrected to exceed the selection probability of the running style aptitude. In addition, in the case where both the red factors tied to the two inheritance characters relate to the distance aptitude, the selection probability of the distance aptitude can be corrected to exceed the selection probabilities of the course aptitude and the running style aptitude.

Also, when one kind of aptitude serving as an earning object is decided in the first process, a factor level is decided from level 1 to level 3 in the second process. The factor level of a red factor is decided by lottery with reference to the aptitude rank at the time character nurturing is ended, and the higher the aptitude rank of the aptitude decided as an earning object in the first process, the more likely a high factor level is to be selected in the second process. In this embodiment, eight stages of aptitude ranks, including S, A, B, C, D, E, F, and G are prepared for each of the aptitudes. In order to be extracted as red-factor earning-object candidates, aptitudes need to have an aptitude rank of A or higher (A or S). In the case where an aptitude selected as a red-factor earning object has an aptitude rank of S, a higher factor level is more likely to be selected for the aptitude than in the case where the aptitude has an aptitude rank of A.

Next, a determination is made as to the unique factor in the first process according to the rarity of the character. In this embodiment, information called a talent-blooming level is available as the rarity of the character serving as a nurturing object, wherein the talent-blooming level is set to one of level 1 to level 5. The talent-blooming level is treated such that level 1 corresponds to the lowest rarity and level 5 corresponds to the highest rarity. Each of the characters has, as an initial status, an acquired skill unique to the character (referred to as a unique skill), and the skill level of the unique skill increases when a predetermined condition is satisfied in the course where the character is nurtured in the nurturing function. The level of the unique skill affects the effect of the skill, and the higher the level of the unique skill, the more profound the effect when the skill is invoked. In the first process related to the unique factor, it is determined that the unique factor can be earned in the case where the talent-blooming level of the character serving as a nurturing object is level 3 or higher (level 3 to level 5). That is, in the case where the talent-blooming level of the character serving as a nurturing object is level 2 or less (level 1 or level 2), it is determined that the unique factor cannot be earned in the first process related to the unique factor. Note that, in the first process related to the unique factor, the unique skill may be referenced, instead of the talent-blooming level, to determine whether or not the unique factor can be earned. In this embodiment, a character with a talent-blooming level of level 2 or lower and the same kind of character with a talent-blooming level of level 3 or higher have different unique skills. Thus, the talent-blooming level of the character can thus be determined substantially with reference to the unique skill.

Also, in the case where it is determined that the unique factor can be earned in the first process, the factor level is decided from level 1 to level 3 in the second process. The factor level of the unique factor is decided by lottery with reference to the skill level of the unique skill of the character serving as a nurturing object, and the higher the skill level, the more likely a high factor level is to be selected in the second process. Note that the factor level of the unique factor may be decided by lottery with reference to the talent-blooming level of the character serving as a nurturing object, and it is also acceptable that the higher the talent-blooming level is, the more likely a high factor level is to be selected in the second process.

Next, a lottery is drawn to decide a white-factor earning object in the first process with reference to the possessed skills and the nurturing history of the character. In this embodiment, a skill factor, a race factor, and a scenario factor are available as the white factor, and earning-object candidates are set for each of the factors. First, regarding the skill factor, factor information corresponding to normal skills (skills other than the unique skill) acquired by the character at the time nurturing is ended is set as earning-object candidates. In addition, regarding the race factor, factor information corresponding to races in which the character entered during character nurturing, that have a race grade thereof set to G1, and in which the character resulted in winning the first place is set as earning-object candidates. Furthermore, regarding the scenario factor, factor information corresponding to the nurturing scenario selected by the player before the start of character nurturing is set as earning-object candidates. Also, whether or not to earn each of the earning-object candidates set for the skill factor, race factor, and scenario factor is decided by lottery, and the earning-object candidates that have been won are decided as white-factor earning objects. Note that, in this embodiment, the higher the nurturing rank of the nurtured character, the more advantageous the winning probability of a lottery for deciding whether or not to earn each of the earning-object candidates. An evaluation score is calculated on the basis of the statuses of a character for which nurturing has been completed and is classified into a character nurturing rank according to rank determination criteria, wherein the higher the evaluation score, the higher the character nurturing rank. That is, when character nurturing is ended with a high nurturing rank, the number of white-factor earning objects tends to increase. In addition, in this embodiment, in the case where the white factors serving as earning-object candidates include a white factor tied to an inheritance character, the winning probability of a lottery for deciding the white factor becomes more advantageous. That is, regarding the white factor, the same factor information as that of the inheritance characters is more likely to be earned.

Also, when white factors serving as earning objects are decided in the first process, the factor level of each of the white factors serving as earning objects is decided from level 1 to level 3 in the second process. The factor level of a white factor is also decided by lottery with reference to the nurturing rank, and the higher the nurturing rank, the more likely a high factor level is to be selected in the second process.

Regarding skill factors of the white factor, as the rarity of a skill possessed by the character is higher, the winning probability of a lottery for deciding the skill factor is more advantageous in the first process, and a high factor level is more likely to be selected in the second process. For example, there are a lower skill (e.g., intermediate-distance straight with circle) and a higher skill (e.g., intermediate-distance straight with double circle) that cannot be simultaneously possessed by one character, and in the case where the character possesses a higher skill at the time nurturing is ended, factor information of the white factor corresponding to the skill (e.g., intermediate-distance straight with circle) is earned with higher priority than in the case where the character possesses a lower skill at the time nurturing is ended.

This embodiment has been described by way of an example where when white-factor earning objects are to be decided, earning-object candidates are extracted from the possessed skills, race entry history, nurturing scenario, etc. of the character, and it is decided whether or not to earn each of the extracted earning-object candidates. However, when a lottery for deciding a white-factor earning object is drawn, a lottery for deciding the number of earning objects may be drawn first at a probability according to the character nurturing rank, and white-factor earning objects may then be decided from the white-factor earning-object candidates within the range of the upper limit number of earning objects determined in the lottery.

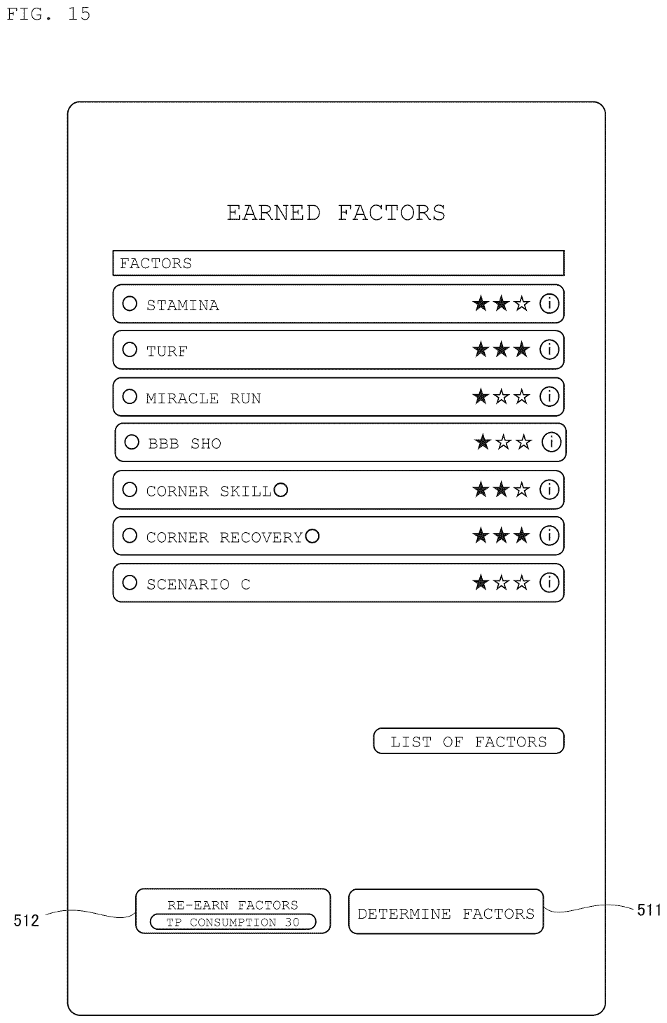

Also, when the result of the lottery for deciding factor information of the character serving as a nurturing object is acquired from the server 20 in the player terminal 40, an earned-factor notification screen shown in FIG. 15 is displayed, notifying the player of the factor information acquired from the server 20 as the factor information earned in this round of nurturing (step S203).

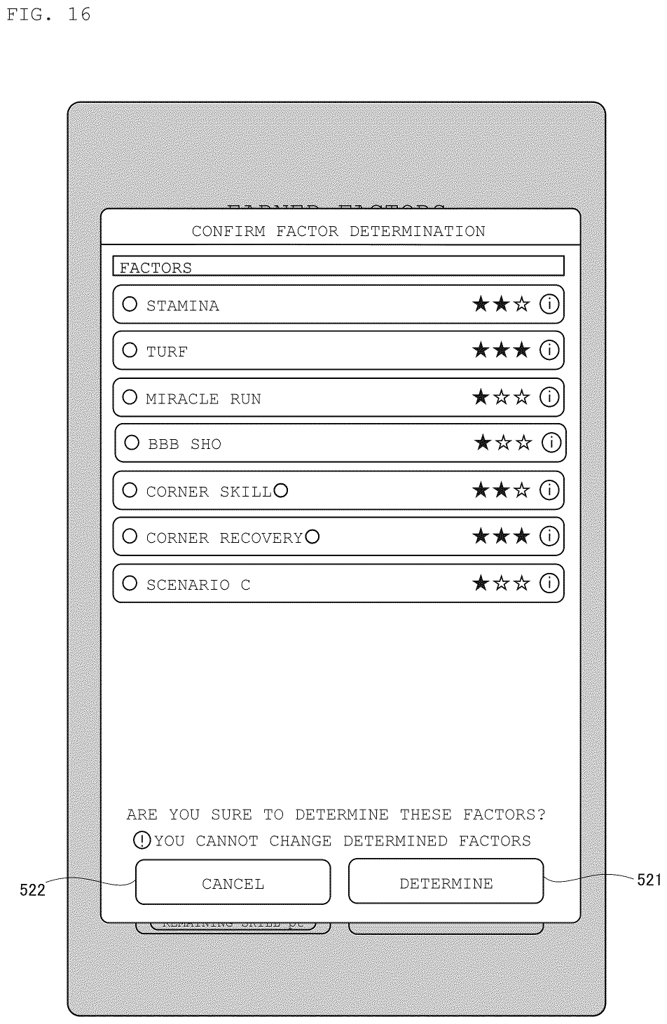

On the earned-factor notification screen, which is provided with a factor determination button 511 and a factor re-earning button 512, the factor information acquired from the server 20 is listed. When a tap input is made to the factor determination button 511 in a state in which the earned-factor notification screen is displayed, a factor-determination confirmation dialog shown in FIG. 16 is displayed. Also, when a tap input is made to a determination confirmation button 521 provided on the factor-determination confirmation dialog (Y in step S204), the factor information to be tied to the character nurtured this time around is determined and is then registered, as a nurtured character, in the character list in the player management database 51 and the character list in the player data storage unit 71 (step S205). Note that in the case where a tap input is made to a cancel button 522 in a state in which the factor-determination confirmation dialog is displayed, the factor-determination confirmation dialog is closed, causing the display screen to return to the earned-factor notification screen.

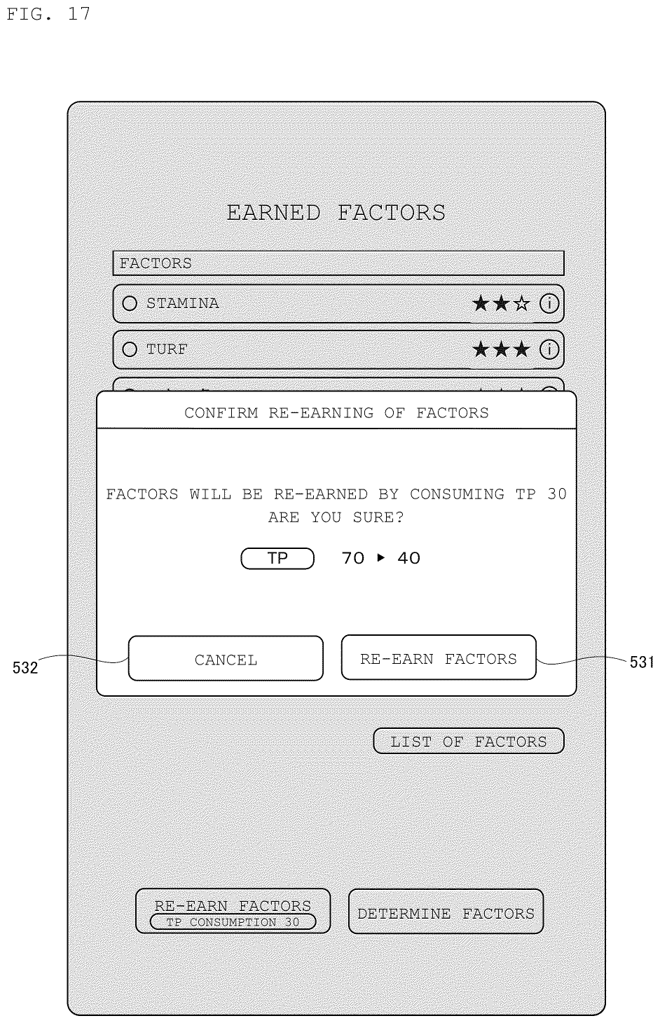

In addition, when a tap input is made to the factor re-earning button 512 in a state in which the earned-factor notification screen is displayed, a factor re-earning confirmation dialog shown in FIG. 17 is displayed. Also, when a tap input is made to a re-earning confirmation button 531 provided on the factor re-earning confirmation dialog (Y in step S206), a factor re-earning request for requesting to re-earn factor information is transmitted from the player terminal 40 to the server 20, thereby allowing the character to re-earn factor information (step S207). Regarding re-earning of factor information, the player is required to consume trainer points (TP) needed when a character is to be nurtured. In the case where the trainer points (TP) possessed by the player are insufficient, the player can re-earn factor information by replenishing trainer points by using a recovery item or the like. Furthermore, this embodiment is designed so that trainer points (TP) are recovered over time by a predetermined amount at a time. Thus, in the case where the earned-factor notification screen is displayed in a state in which the trainer points (TP) possessed by the player are insufficient to re-earn factor information, the player can resume the nurturing function after transitioning to another screen, such as resuming the nurturing function after calling another function of the application or resuming the nurturing function by starting the application after ending the application by means of task kill, thereby possibly allowing the character to re-earn factor information by possessing trainer points (TP) recovered over time. In this embodiment, the character can re-earn factor information by consuming the trainer points (TP) equivalent to the consumption needed to start character nurturing. In the server 20 that has received the factor re-earning request, a lottery for deciding factor information is re-drawn on the basis of the factor re-earning request, and the lottery result is transmitted to the player terminal 40. In particular, in this embodiment, in a factor-information deciding lottery to be drawn on the basis of the factor re-earning request, each of the blue factor, the red factor, the unique factor, and the white factor is subjected to the first process and the second process under the same conditions as those for the lottery for deciding factor information drawn on the basis of the factor earning request that has been made earlier, thereby deciding factors serving as earning objects and the factor levels thereof. Note that a cancel button 532 is also provided in the factor re-earning confirmation dialog, and when a tap input is made to the cancel button 532, the display screen returns to the earned-factor notification screen.

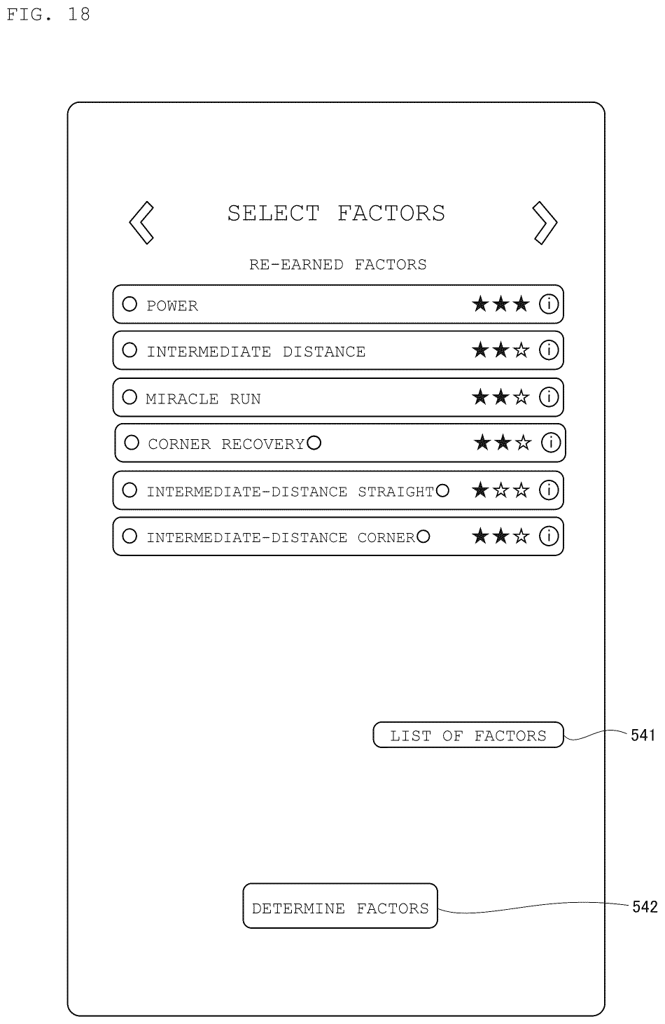

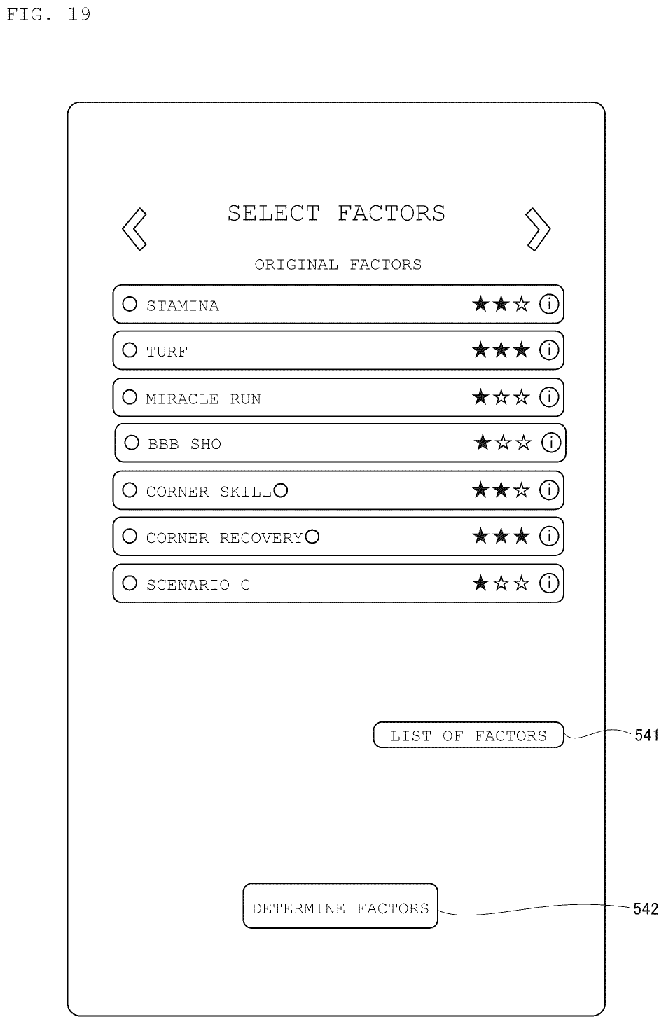

Also, when the lottery result of the factor information of the character serving as a nurturing object is acquired from the server 20 in the player terminal 40, an earning-factor selection screen shown in FIG. 18 and FIG. 19 is displayed, and the player is notified of the factor information acquired from the server 20 on the basis of the factor re-earning request in such a manner that the re-earned factor information can be compared with the factor information acquired earlier (step S208). Note that the factor information acquired from the server 20 on the basis of the factor re-earning request may be only the factor information decided on the basis of the factor re-earning request or may be both the original factor information decided on the basis of the factor earning request and the new factor information decided on the basis of the factor re-earning request.

On the earning-factor selection screen, factor information acquired earlier is displayed as “original factors”, as shown in FIG. 19, and factor information acquired later is displayed as “re-earned factors”, as shown in FIG. 18. Display can be switched between the “original factors” and the “re-earned factors” by making a swipe input either leftward or rightward on the earning-factor selection screen.

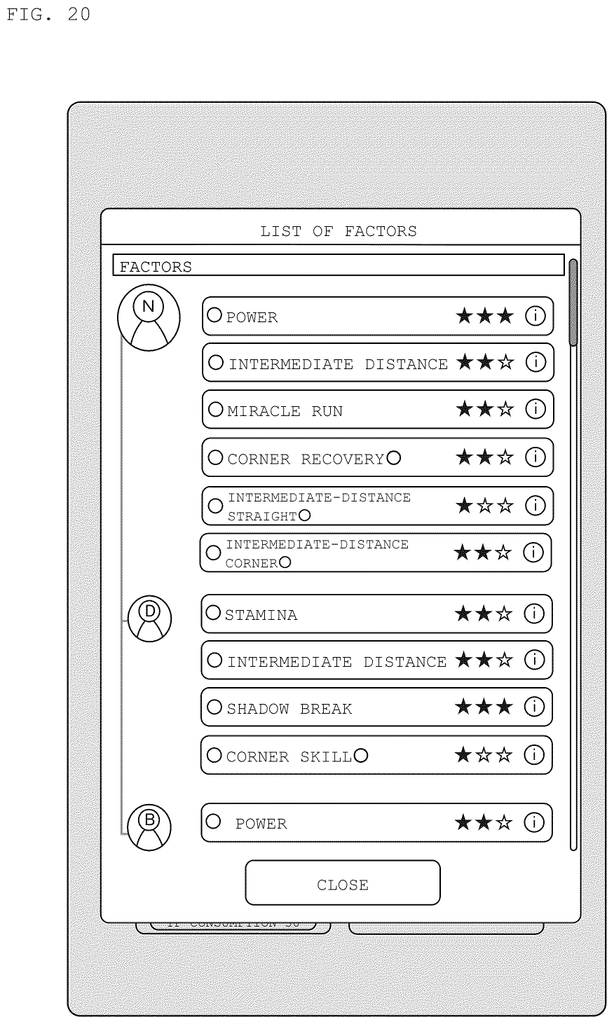

In addition, when a tap input is made to a factor list button 541 provided on the earning-factor selection screen, a factor list dialog is displayed, as shown in FIG. 20, and the factor information of the character serving as a nurturing object (e.g., character N) and two inheritance characters (e.g., character D and character B) are tree-displayed, thereby allowing the player to confirm in advance factor information that would be earned if the character serving as a nurturing object were registered as a nurtured character in the character list. Note that the factor information of the character serving as a nurturing object that is displayed in the factor list dialog is the factor information displayed on the earning-factor selection screen. That is, in the case where the factor list dialog is displayed in a state in which the “original factors” are displayed on the earning-factor selection screen, the “original factors” will be the factor information of the character serving as a nurturing object. On the other hand, in the case where the factor list dialog is displayed in a state in which the “re-earned factors” are displayed on the earning-factor selection screen, the “re-earned factors” will be the factor information of the character serving as a nurturing object.

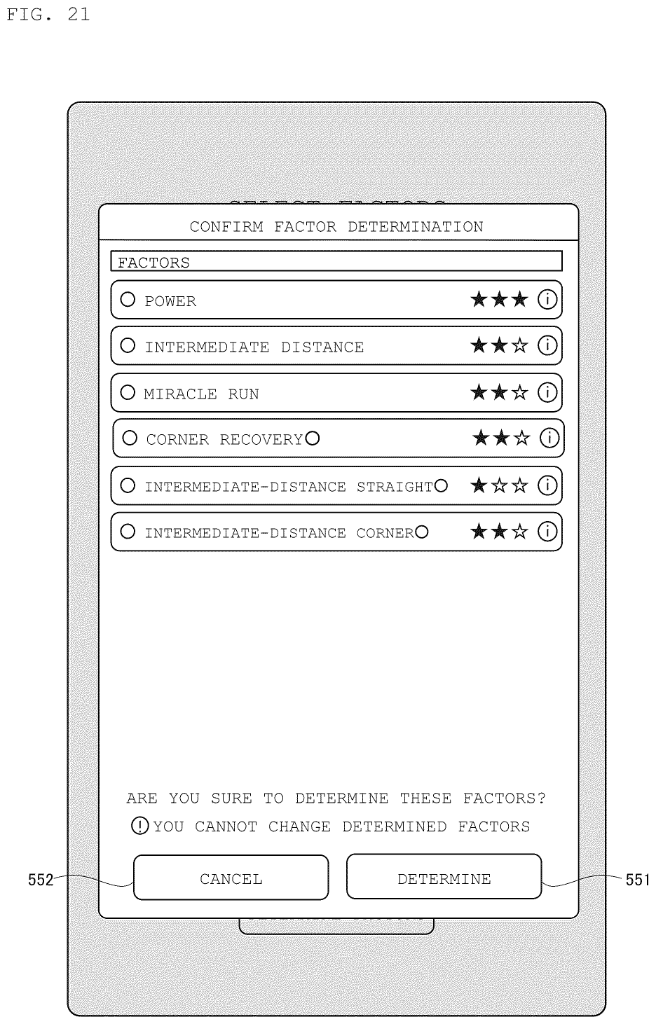

A factor determination button 542 is also provided on the earning-factor selection screen, and when a tap input is made to the factor determination button 542, the factor-determination confirmation dialog is displayed assuming that the player has selected the factor information being displayed on the earning-factor selection screen. For example, as shown in FIG. 18, when a tap input is made to the factor determination button 542 in a state in which “re-earned factors” are selected, the factor-determination confirmation dialog in which the factor information corresponding to the “re-earned factors” is displayed appears, as shown in FIG. 21. Also, when a tap input is made to a determination confirmation button 551 provided in the factor-determination confirmation dialog (Y in step S209), the factor information to be tied to the character nurtured this time round is determined, and is then registered as a nurtured character in the character list in the player management database 51 and the character list in the player data storage unit 71 (step S205). Note that in the case where a tap input is made to a cancel button 552 in a state in which the factor-determination confirmation dialog is displayed, the factor-determination confirmation dialog is closed, causing the display screen to return to the earning-factor selection screen.

In this embodiment, a lottery for deciding factor information to be tied to the character is redrawn under the same conditions as those for the factor information that has been reported to the player, and this readily works as a trigger for the player to decide to re-earn factor information. Note that this embodiment is designed so that a lottery is repeatedly drawn to decide factor information for one character. In the case where factor information is to be re-earned, however, the player may be allowed to internally produce a duplicated character by tracing the nurturing history of the nurtured character (original character), decide factor information for the duplicated character, and select which of the original character and the duplicated character to register. Note that conditions for a lottery related to re-earning of factor information (second lottery) do not always need to be the same as those for the first lottery. The second lottery related to re-earning of factor information may be probabilistically more advantageous or disadvantageous in re-earning factor information than the first lottery. Furthermore, in the case where a lottery related to re-earning of factor information is to be drawn, a lottery related to deciding factor information may be drawn with reference to internally corrected statuses of the character. For example, in a lottery for deciding a white-factor earning object, the character nurturing rank may be internally corrected to S in the lottery related to re-earning even though the character actually has a nurturing rank of A, thereby making it possible to draw the lottery for deciding a white-factor earning object under more advantageous conditions than those with the original nurturing rank.

In addition, in this embodiment, in the case where factor information is re-earned, the factor information that has been acquired earlier and the factor information that has been acquired later are displayed on the earning-factor selection screen so that the two items of factor information can be compared, thereby allowing the player to select which of the two items of factor information should be tied to the character. That is, because the player can determine factor information to be tied to the character at his/her discretion by comparing the factor information concerning the “original factors” and factor information concerning the “re-earned factors”, the convenience to the player can be enhanced. In this embodiment, the player is allowed to select factor information to be tied to the character by comparatively considering the “re-earned factors” while retaining the “original factors”. However, in the case where re-earning of factor information is requested, the factor information corresponding to the “original factors” may be discarded, and the factor information corresponding to the “re-earned factors” may be registered so as to be tied to the character.

Moreover, this embodiment has been described by way of an example where the display on the earning-factor selection screen is switched between the factor information concerning the “original factors” and the factor information concerning the “re-earned factors” via a swipe input. However, it is also acceptable to display the factor information concerning the “original factors” and the factor information concerning the “re-earned factors” on the same screen, so that the player can compare and confirm both factor information without switching the display. In addition, on the earning-factor selection screen, one of the factor information concerning the “original factors” and the factor information concerning the “re-earned factors” may be displayed so as to show the differences from the other.

Moreover, this embodiment has been described by way of an example where factor information can be re-earned only once. However, the character may be able to re-earn factor information multiple times on condition that trainer points (TP) are consumed as a remuneration. In the case where factor information can be re-earned repeatedly, the present embodiment may be designed so that the consumption of trainer points (TP) needed to re-earn factor information is increased each time factor information is re-earned.

Furthermore, the remuneration for re-earning factor information may be classified into stages, so that when factor information is to be re-earned, the character is favored at the player's discretion according to the stage of the consumed remuneration. For example, the present embodiment may be designed so that in the case where factor information is to be re-earned, a larger number of white factors can be earned as the consumption of trainer points (TP) becomes higher.

In addition, in this embodiment, a predetermined amount of trainer points (TP) need to be consumed on each round of character nurturing in the nurturing function, and this consumption may vary only within a period of time due to an event, a campaign, or the like. In contrast, trainer points (TP) consumed when factor information is to be re-earned are equivalent to a predetermined amount of trainer points (TP) needed for one round of normal nurturing. That is, in this embodiment, factor information can be re-earned by consuming a certain amount of trainer points (TP), without linking to the consumption of trainer points (TP) when nurturing is started. However, the consumption of trainer points (TP) needed to re-earn factor information may vary in conjunction with the consumption of trainer points (TP) when nurturing is started. Furthermore, in this embodiment, there is a remuneration needed to pay for re-earning of factor information. However, it is also acceptable that factor information can be re-earned without a remuneration.

Furthermore, although this embodiment has been described by way of an example where a lottery related to re-earning of factor information is drawn on the basis of an input made by the player, two lotteries (first lottery and second lottery) may be drawn in advance under the same conditions at the time character nurturing is ended, and the result of only the first lottery may be presented, so that the second lottery result is presented on the basis of an input made by the player. In the case where two lotteries are drawn in advance, which of the lottery results should be presented can be determined according to pre-defined priority. For example, the lottery results to be presented first can be decided according to an arbitrary reference, such as the number of items of earned factor information or the factor level of particular factor information.

Furthermore, the present embodiment may be designed so that when factor information is to be re-earned, a lock can be set with regard to original factor information, so that factor information having a lock set therefor is transferred to the re-earned factor information. In the case where a lock can be set with regard to original factor information, it may be allowed to set a lock only for one kind of the blue factor, red factor, and unique factor, set a lock for all of the blue factor, red factor, and unique factor, or re-decide only the white factor. It is also allowed to set a lock for white factors within a limited number of white factors.

Thus, when one character is nurtured with the nurturing function of this embodiment, the player is entitled to two lotteries for selecting factor information to be tied to the character for which nurturing is ended. However, in the case where the “original factor” and the “re-earned factor” serving as selection candidates are not factor information desired by the player, it is necessary to nurture a character again by using the nurturing function.

Given that, this embodiment is newly provided with a factor changing function for allowing factor information tied to a nurtured character to be changed in exchange for the consumption of a factor-changing item.

First, a method for obtaining a factor-changing item will be described. In this embodiment, the event parameter is updated so as to accumulatively increase each time the nurturing function and the competition function are used, and the player is entitled to a reward decision lottery that allows a reward to be earned each time the event parameter reaches a predetermined value. A plurality of kinds of items including a factor-changing item are prepared as rewards that can be earned by a reward decision lottery, so that a factor-changing item can be obtained by winning one when a reward decision lottery is drawn.

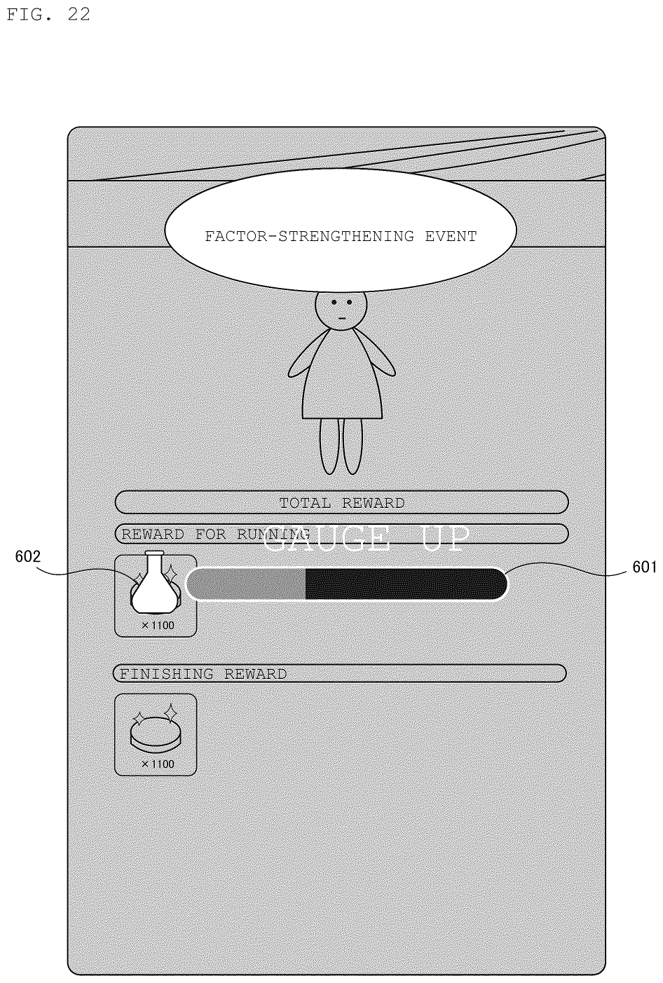

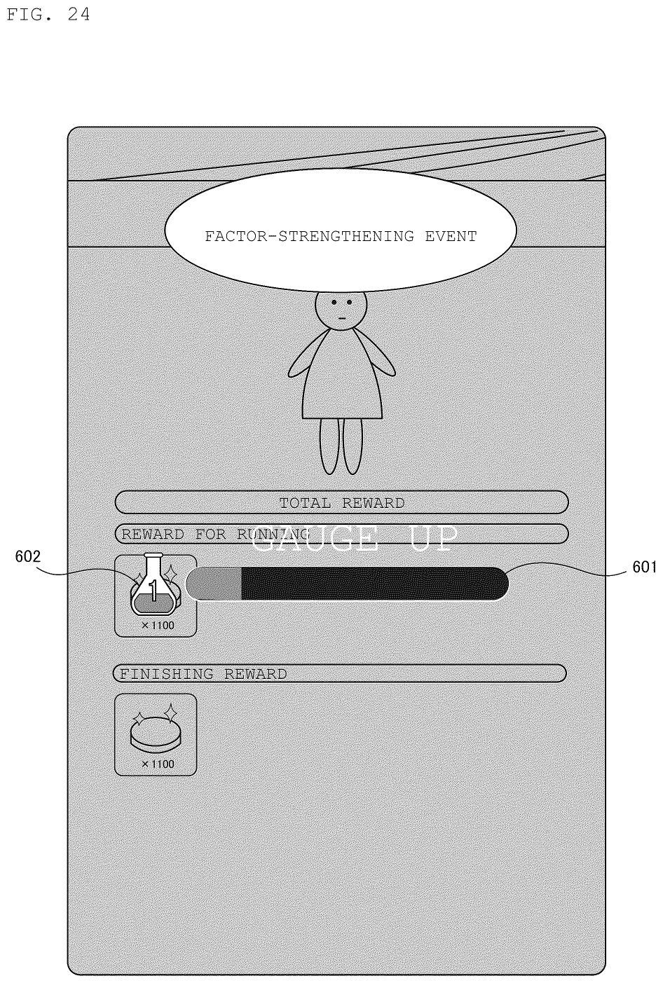

FIGS. 22 to 24 are drawings showing an example of executing parameter update presentation, reporting the content of the updated event parameter.

For example, in the case where a character is nurtured in the nurturing function, the event parameter is updated in the nurturing ending process, and parameter update presentation is executed after display of the result of character nurturing is completed. In addition, for example, in the case where a nurtured character is made to enter in a race in the competition function, the event parameter is updated at the time a race entry result is acquired from the server 20, and parameter update presentation is executed after display of the race entry result is completed.

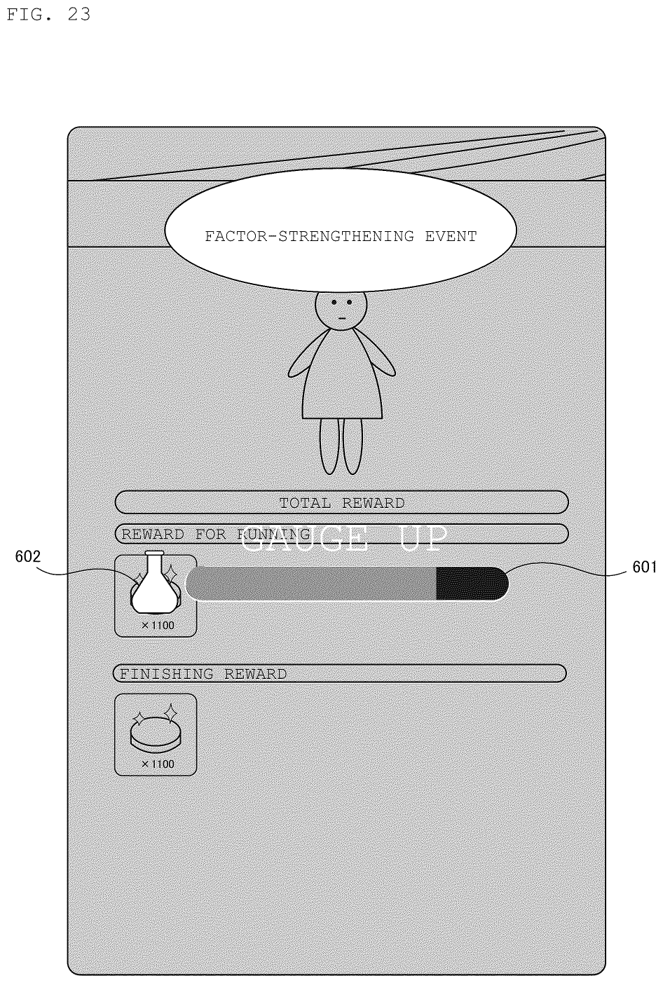

In parameter update presentation, the player is notified of the amount of accumulated event parameter via a parameter gauge 601 and a flask icon 602. The parameter gauge 601 plays a role of reporting the amount of accumulated event parameter until the reward earning condition is satisfied, and an increase in the gauge amount of the parameter gauge 601 is displayed in animation, as shown in, for example, FIGS. 22 and 23, in conjunction with the amount of updated event parameter obtained as a result of the nurturing function and the competition function being used.

The flask icon 602 plays a role of reporting the number of earned rewards and is displayed in a different manner so as to be incremented each time the event parameter reaches a predetermined amount. For example, as shown in FIGS. 22 to 24, in the case where the gauge amount of the parameter gauge 601 increases so as to exceed a predetermined amount as a result of the event parameter being updated, the manner in which the flask icon 602 is displayed changes, displaying a numeric character indicating the number of earned rewards.

In this embodiment, each time the event parameter reaches a determination value “10”, the reward earning condition is satisfied. That is, in this embodiment, a determination value is set as a reference value for determining an increase in the gauge amount of the parameter gauge 601 exceeding the aforementioned predetermined amount. Also, the display content of the parameter gauge 601 and the flask icon 602 is obtained by dividing the event parameter by the determination value. More specifically, a quotient and a remainder are obtained by dividing the event parameter by the determination value, so that the quotient is applied to display of the flask icon 602 as the number of earned rewards, and the remainder is applied to display of the parameter gauge 601 as the gauge amount. Note that a numerical value related to the determination value may be displayed on the screen for displaying the parameter gauge 601. In addition, when the number of earned rewards is one or more, a message reporting that a reward can be earned may be displayed on the screen for displaying the flask icon 602.

Note that the event parameter and the number of earned rewards may be managed so as to measure the event parameter with a counter that changes cyclically within the range of 0 to 10, thereby incrementing the value of the counter for counting the number of earned rewards each time the value of the counter for measuring the event parameter reaches “10”. In this case, when a reward decision lottery is executed, the value of the counter for measuring the number of earned rewards is reset. In the case where the number of earned rewards is managed independently of the event parameter, the event parameter is measured each time the content for updating the event parameter, such as the nurturing function and the competition function, is ended, and when the measured event parameter satisfies the reward earning condition as a result of reaching the maximum value “10”, the number of earned rewards is updated.

Subsequently, specific examples of an aspect for updating the event parameter will be described.

In an example of the aspect, the event parameter is raised by a fixed amount (e.g., 1) each time the nurturing function or the competition function is used once, without discriminating the two functions from each other. In this case, it is not necessary to consider which of the nurturing function and the competition function is used by the player in measuring the amount of updated event parameter.

In another example of the aspect, the amount of increase in the event parameter is larger in the case where the nurturing function is used once than in the case where the competition function is used once. That is, the amount of increase in the event parameter may differ between when the nurturing function is used and when the competition function is used. More specifically, an update aspect in which the event parameter is raised by “3” per use of the nurturing function and the event parameter is raised by “1” per use of the competition function can be employed. In this embodiment, when the nurturing function is compared with the competition function, the two functions differ in the time taken to use each function. More specifically, the time taken to complete nurturing of one character in the nurturing function is generally longer than the time taken to obtain the result of the competition in the competition function. For this reason, the player is motivated to use the nurturing function because the amount of increase in the event parameter is larger in the case where the nurturing function, which takes a longer time to use the game function, is used than in the case where the competition function is used.

Also, in another example of the aspect, in the case where the nurturing function is used, the amount of increase in the event parameter differs according to the result of character nurturing. More specifically, it is possible to employ an update aspect in which, of the factor information to be tied to the nurtured character, the event parameter is raised by “1” if the total of the three factor levels (number of stars) of the blue factor, red factor, and unique factor is 3 or less, the event parameter is raised by “2” if the total of the aforementioned three factor levels is 4 to 6, and the event parameter is raised by “3” if the total of the aforementioned three factor levels is 7 or larger. Furthermore, of the factor information to be tied to the nurtured character, the total of the three factor levels (number of stars) of the blue factor, red factor, and unique factor may serve as the amount of increase in the event parameter. In the nurturing function of this embodiment, the better the result of nurturing, the more easily factor information with a higher factor level can be obtained. Therefore, if the amount of an increase in the event parameter is made to differ according to the result of character nurturing, it is possible to evoke the player's enhanced mind of nurturing an excellent character in the nurturing function. In addition, another example of the aspect may be designed so that when the nurturing function is used, the amount of increase in the event parameter differs according to the degree of proceeding of the nurturing scenario at the time character nurturing is ended, more specifically, so that the higher the degree of proceeding (including the number and the achievement rate of achieved nurturing goals, the number of consumed turns, the results of the races in the extra turns, etc.) of the nurturing scenario at the time character nurturing is ended, the more likely the event parameter is to be raised. Also, in another example of the aspect, when the nurturing function is used, the amount of increase in the event parameter may be set according to the nurturing scenario selected before the start of character nurturing.

Moreover, in another example of the aspect, in the case where the competition function is used, the amount of increase in the event parameter differs according to the result of the competition. More specifically, an update aspect in which the event parameter is raised by “2” if a victory is determined in the competition function, and the event parameter is raised by “1” if a result other than the victory (defeat or draw) is determined in the competition function may be employed. Note that “victory” in the competition function means the character of the current player winning the first place in the case of the daily race and the daily legend race, and the team of the current player defeating the opponent's team by earning three wins in the five races in the case of the team stadium.

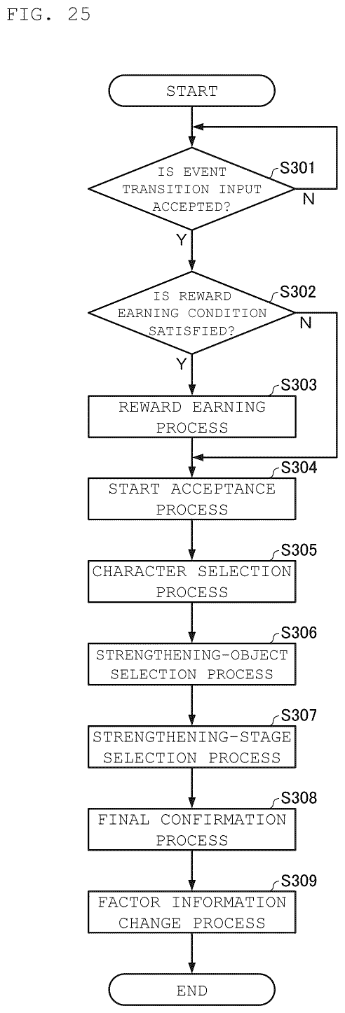

Subsequently, the flow of processing related to the factor changing function will be described along the flowchart shown in FIG. 25.

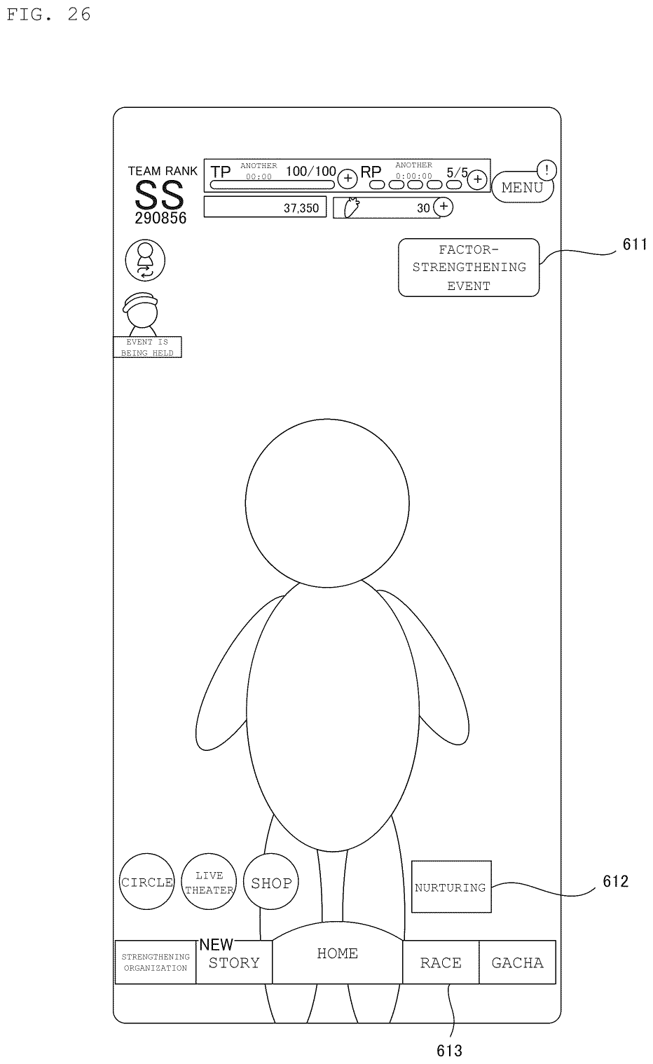

First, in this embodiment, an input for transitioning to the factor changing function (event transition input) is accepted on the home screen (step S301). As shown in FIG. 26, an event icon 611 is provided on the home screen, and when a tap input (event transition input) is made to the event icon 611 (Y in step S301), it is determined whether or not the reward earning condition is satisfied with reference to the event parameter stored in the event data storage unit 74 (step S302).

In this embodiment, it is determined whether or not the reward earning condition is satisfied on the basis of the quotient obtained by dividing the event parameter by the determination value, and it is determined that the reward earning condition is satisfied if the quotient obtained by dividing the event parameter by the determination value is not 0 (or the quotient is 1 or larger). For example, in the case where the event parameter is 32 and the determination value is 10, the quotient obtained by dividing the event parameter by the determination value is 3, and therefore, it is determined that the reward earning condition is satisfied.

In the case where it is determined that the reward earning condition is satisfied (Y in step S302), a reward earning process is executed (step S303), and in the case where it is determined that the reward earning conditions is not satisfied (N in step S302), the flow proceeds to a start acceptance process by skipping the reward earning process (step S304).

In the reward earning process, a reward decision request including information concerning the quotient and the remainder obtained by the aforementioned division is transmitted to the server 20. In the server 20 that has received the reward decision request, a reward to be provided is decided by drawing a reward decision lottery as many times as the number of rewards to be earned, which is represented by the aforementioned quotient. Also in the server 20, the event parameter of the reward-receiving player stored in the event management database 53 is updated as a result of being overwritten with the aforementioned remainder. For example, in the case where the aforementioned event parameter is 32 and the determination value is 10, the event parameter, which is 32, is overwritten with 2 on the basis of the quotient being 3 and the remainder being 2.

Also, when drawing the required number of reward decision lotteries is completed, the server 20 adds a reward to be provided to the item list of the reward-receiving player in the player management database 51 and transmits, to the player terminal 40, a reward decision response including information concerning the rewards to be provided and the updated event parameter. In the player terminal 40 that has received the reward decision response, the rewards decided as provided to the player are added to the item list in the player data storage unit 71, and the event parameter stored in the event data storage unit 74 is updated on the basis of information concerning the event parameter included in the reward decision response. Thus, in this embodiment, not only can the number of rewards to be earned be determined by using the quotient obtained as a result of the event parameter being divided but also the consumption of the event parameter in exchange for the earning of rewards can be managed by using the remainder.

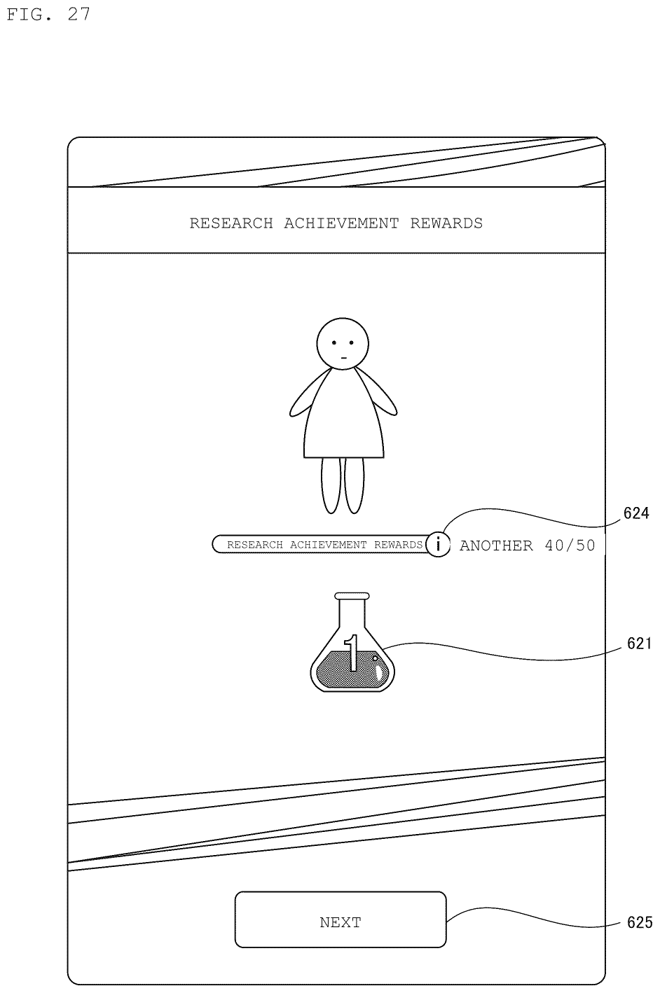

In addition, in this embodiment, in the case where the reward earning process is executed, reward-earning presentation for reporting the rewards decided as provided to the player is executed in the player terminal 40. FIGS. 27 to 29 are drawings showing an example of executing reward-earning presentation.

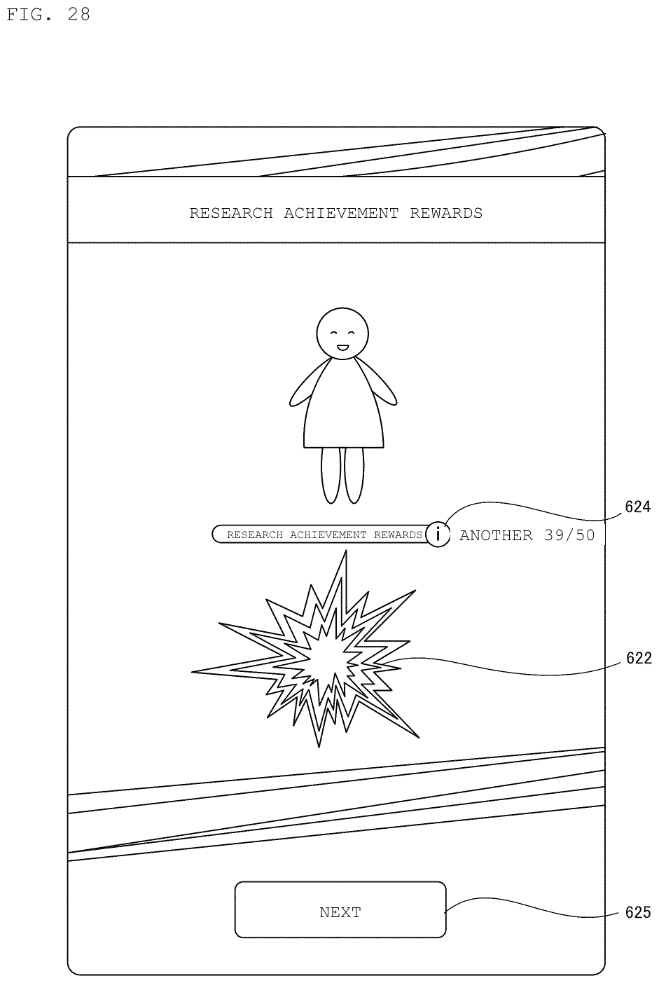

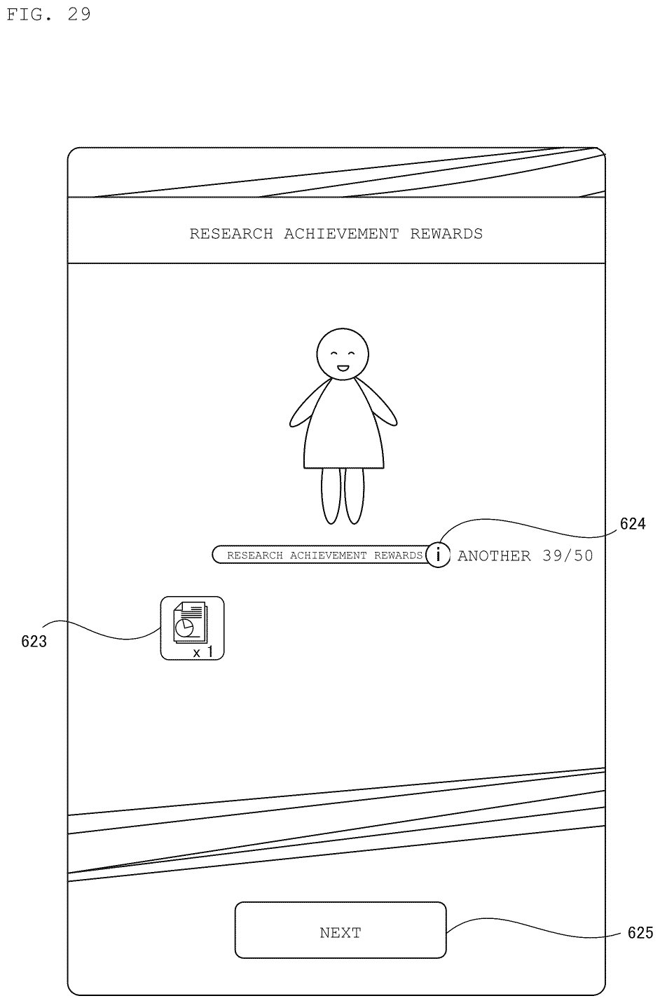

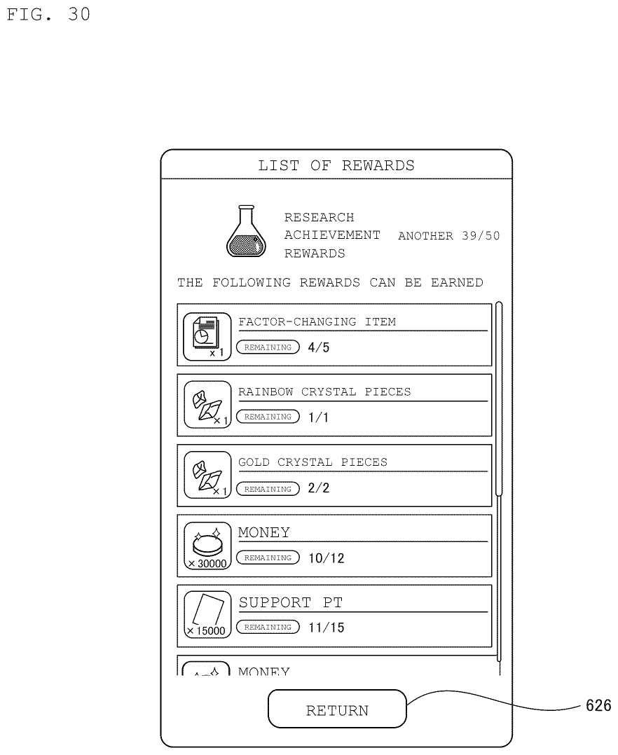

In the reward-earning presentation, the display of a flask icon 621 (refer to FIG. 27) with an indication of the number of rewards to be earned changes to the display of an explosion effect 622 (refer to FIG. 28), eventually executing animation processing for reporting the content of reward by means of a reward icon 623 (refer to FIG. 29). A reward confirmation button 624 is provided on the display screen while the reward-earning presentation is being executed, and when a tap input is made to the reward confirmation button 624, a reward list dialog is displayed, as shown in FIG. 30. In the reward list dialog, a list of rewards that can be earned in relation to the factor-strengthening event this time around is displayed. Furthermore, a return button 626 is provided in the reward list dialog, and when a tap input is made to the return button 626, the display screen returns to the display screen related to reward-earning presentation.

Also, a proceeding button 625 is provided on the display screen while reward-earning presentation is being executed, and when a tap input is made to the proceeding button 625, the reward-earning presentation is ended, causing the flow to proceed to the start acceptance process (step S304).

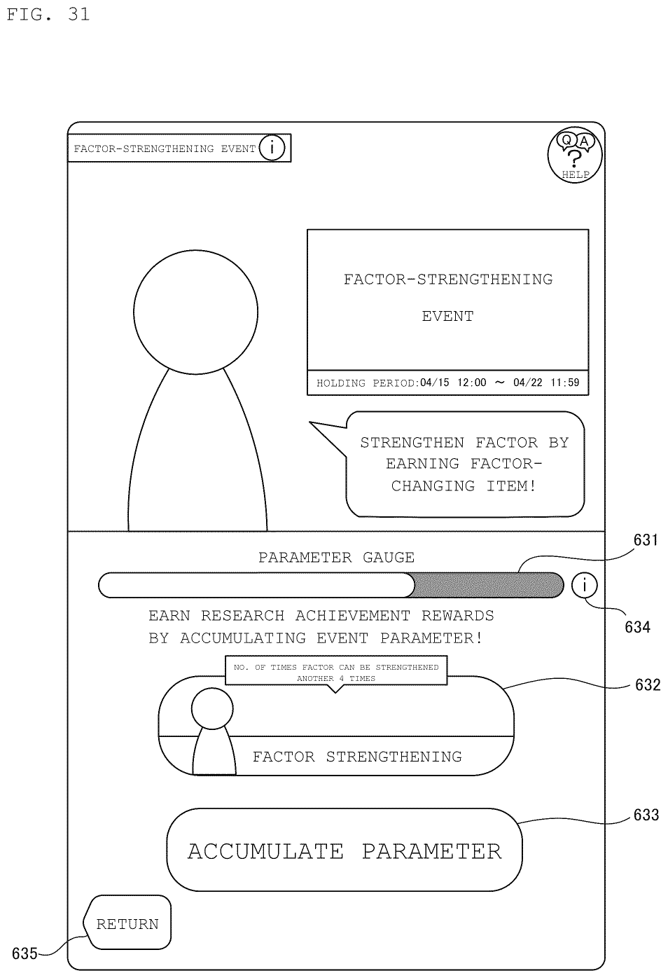

In the start acceptance process, various kinds of inputs as to the factor changing function are accepted via an event top screen. FIG. 31 is a drawing showing an example of display of the event top screen in a state in which there are rewards that are yet to be earned.

As shown in FIG. 31, a parameter gauge 631, a function start button 632, and a function transition button 633 are provided on the event top screen.

The parameter gauge 631 allows the accumulation of the current event parameter to be visually recognized. When a tap input is made to a reward confirmation button 634 provided near the parameter gauge 631, the reward list dialog shown in FIG. 30 is displayed.

The function start button 632 accepts an input for starting the use of the factor changing function and is enabled in the case where the player possesses a factor-changing item. For this reason, in the case where the display screen transitions to the event top screen in a state in which the player does not possess a factor-changing item, the function start button 632 is disabled and appears grayed out. Also, the function start button 632 indicates the number of times the factor changing function can be used, allowing the player to grasp the remaining number of times the factor changing function can be used before it is actually used.

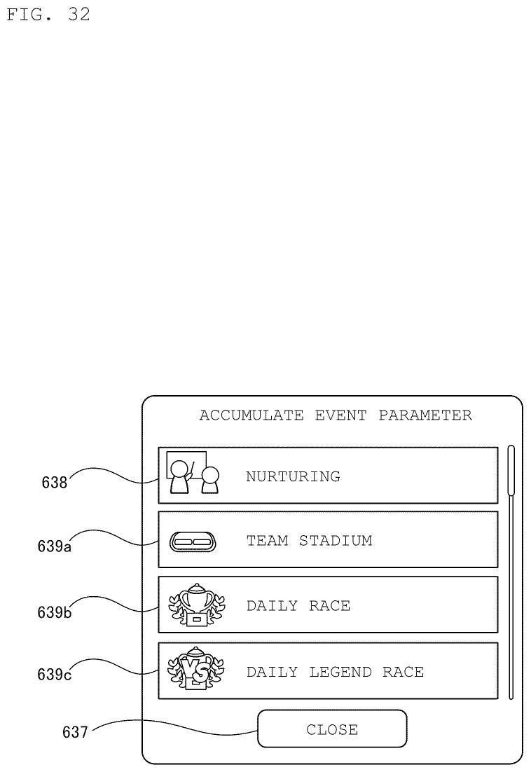

The function transition button 633 is used to quickly transition to the nurturing function and the competition function in order to accumulate the event parameter. When a tap input is made to the function transition button 633, a function guidance dialog is displayed, as shown in FIG. 32. In the function guidance dialog, a nurturing transition button 638 for transitioning to the nurturing function and competition transition buttons 639a to 639c for transitioning to the competition function are provided as buttons for transitioning to game functions in which the event parameter can be accumulated. Note that, in this embodiment, an input for using the nurturing function and the competition function is accepted in principle by means of a nurturing transition button 612 and a competition transition button 613 provided on the home screen shown in FIG. 26. For example, in a state in which the home screen is displayed, use of the nurturing function can be started when a tap input is made to the nurturing transition button 612, and use of the competition function can be started when a tap input is made to the competition transition button 613. Also, in this embodiment, it is necessary to use the nurturing function and the competition function in order to accumulate the event parameter, and because the player can be guided to transition from the event top screen to the nurturing function or the competition function without having to return to the home screen, convenience to the player is enhanced. Note that, in a state in which all rewards that can be earned in a factor-strengthening event have been earned, the function transition button 633 is disabled and appears grayed out.

Also, when a tap input is made to the function start button 632 in a state in which the function start button 632 is enabled on the event top screen, the display screen transitions to a character selection screen, and a character selection process for accepting selection of a character is executed (step S305).

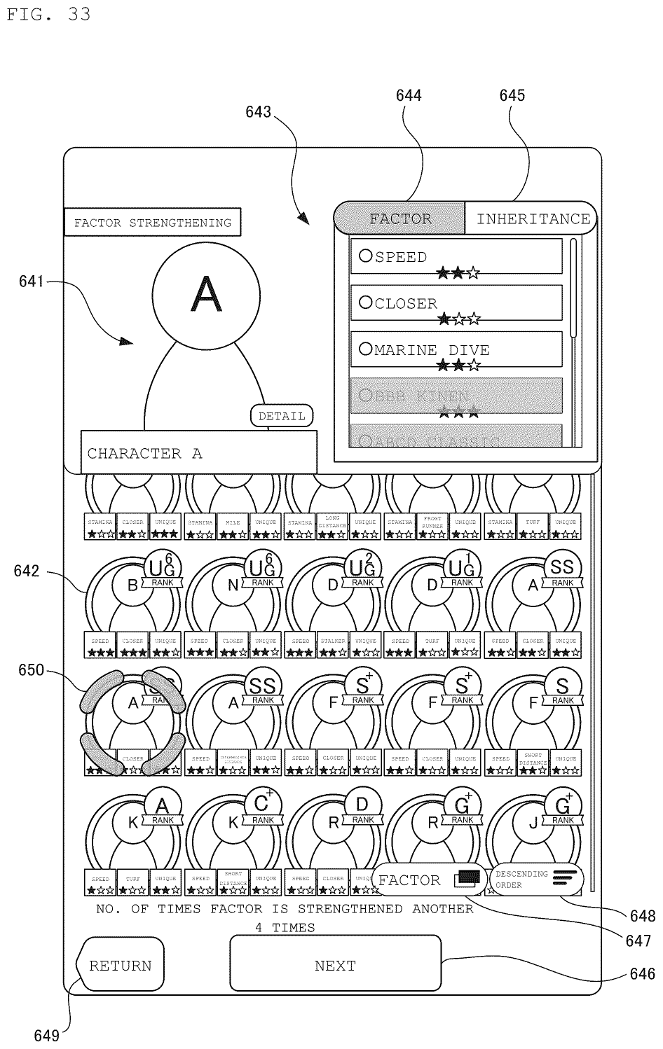

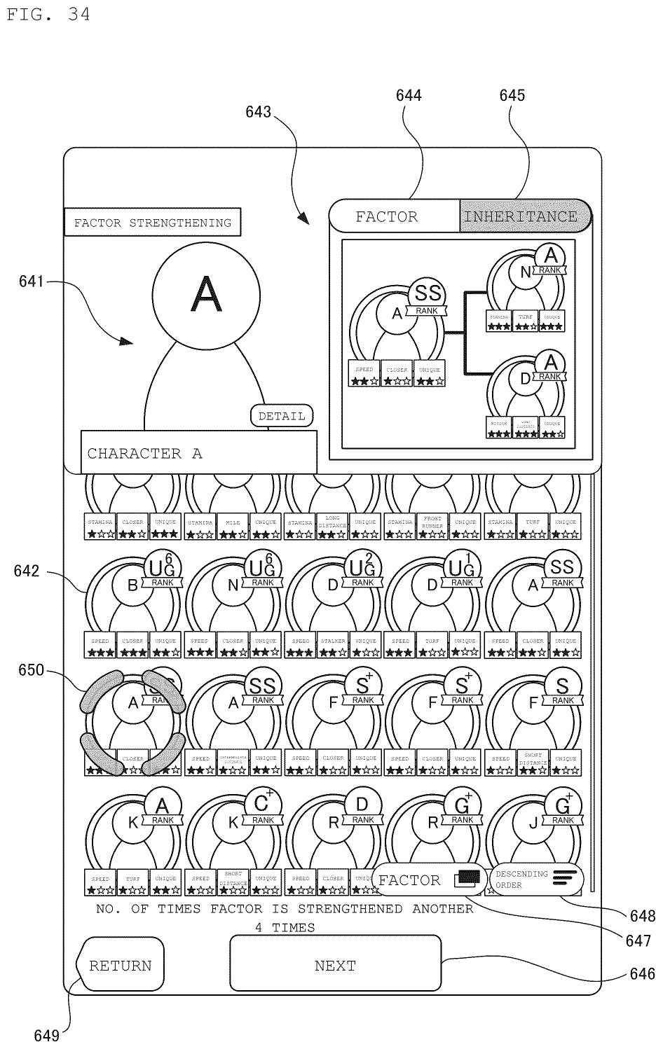

FIGS. 33 and 34 are drawings showing an example of display of the character selection screen. On the character selection screen, a list of nurtured characters possessed by the player is displayed with character icons 642, and an arbitrary nurtured character can be selected by making a tap input to the corresponding character icon 642. A selection mark 650 is imparted to the character icon 642 of the nurtured character being selected, and an image of the nurtured character being selected is displayed in a character display region 641. A factor-related information display region 643 is provided to the right of the character display region 641, and factor information concerning the nurtured character being selected and inheritance characters are displayed in the factor-related information display region 643. The content of factor information displayed in the factor-related information display region 643 can be changed by using a factor tab 644 and an inheritance tab 645. In the display example shown in FIG. 33, the factor tab 644 is selected, and the factor information of the nurtured character being selected that has been tied to the character when the nurturing of the character is ended is displayed in the factor-related information display region 643. In a state in which the factor tab 644 is selected, the red factor, the blue factor, and the unique factor are normally displayed, and the white factor is grayed out to make the selection candidates identifiable. Note that the blue factor, red factor, and unique factor may also be grayed out if the factor levels thereof are highest. Also, when a tap input is made to the inheritance tab 645, the display content in the factor-related information display region 643 changes to a relational diagram between the nurtured character being selected and the inheritance characters as shown in FIG. 34.

In addition, the sort key can be changed by making a tap input to a sort key change button 647 provided on the character selection screen. Furthermore, the sort order can be changed between ascending order and descending order by making a tap input to a sort order change button 648 provided on the character selection screen. In this embodiment, “name”, “registration date”, etc., in addition to “factor”, can be selected as the sort key. Thus, as a result of allowing the sort key and the sort order to be changed, the player can select a nurtured character the factor information of which is to be changed by comparing and considering his/her own possessed nurtured characters from various perspectives.

Also, in order to enhance visual recognizability and ease of operation related to the selection of a nurtured character, a narrow-down function may be provided on the character selection screen. For example, aptitudes, factors, etc. may be specified in more detail, so that only nurtured characters that satisfy the detailed conditions can be displayed.

In addition, a limit may be imposed on the selection of nurtured characters on the character selection screen. For example, on the character selection screen, it is possible to gray out the nurtured characters possessed by the player if all the blue factors, red factors, and unique factors thereof have the highest factor level to inhibit selection of the grayed-out factors, or alternatively, it is possible to hide such nurtured character on the character selection screen. Furthermore, candidates for the nurtured character the factor information of which can be changed by using the factor changing function may be limited to only some characters, so that the candidates for the nurtured character the factor information of which can be changed may be changed in a factor-strengthening event that is held in another time period. In addition, taking into account a case where a nurtured character used as an inheritance character is rented from another player registered as a friend, as designed in this embodiment, a nurtured character allowed by one player to be rented by another player as an inheritance character may be restricted such that the factor information of the nurtured character cannot be changed.

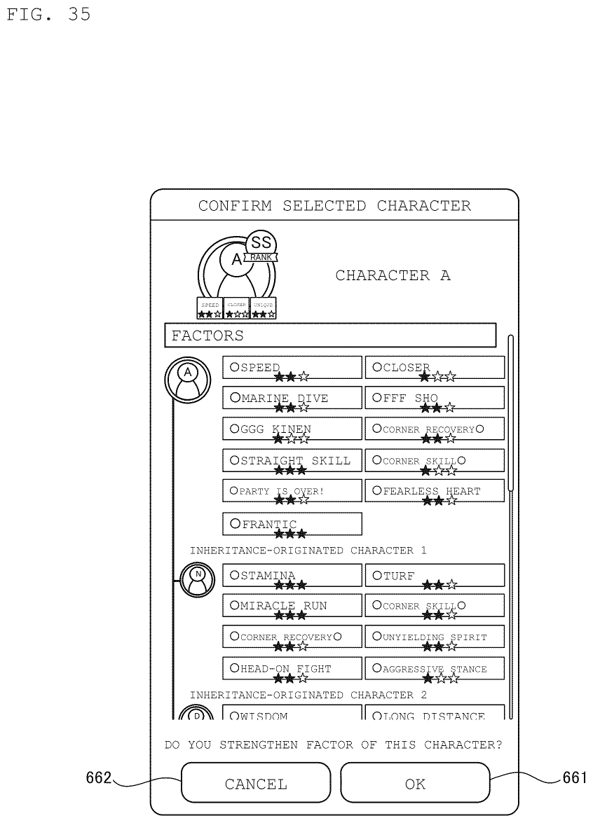

Also, when a tap input is made to a proceeding button 646 in a state in which the character selection screen is displayed, a selected-character confirmation dialog is displayed, as shown in FIG. 35. Moreover, when a tap input is made to a return button 649 in a state in which the character selection screen is displayed, the display screen returns to the event top screen.

In the selected-character confirmation dialog, factor information tied to the nurtured character being selected and factor information of inheritance characters are listed. An OK button 661 and a cancel button 662 are provided in the selected-character confirmation dialog, and when a tap input is made to the OK button 661, the content of the selected nurtured character is determined, the display screen transitions to a strengthening-object selection screen, and a strengthening-object selection process for accepting selection of factor information of a strengthening object is executed (step S306). Furthermore, when a tap input is made to the cancel button 662 in a state in which the selected-character confirmation dialog is displayed, the display screen returns to the character selection screen.

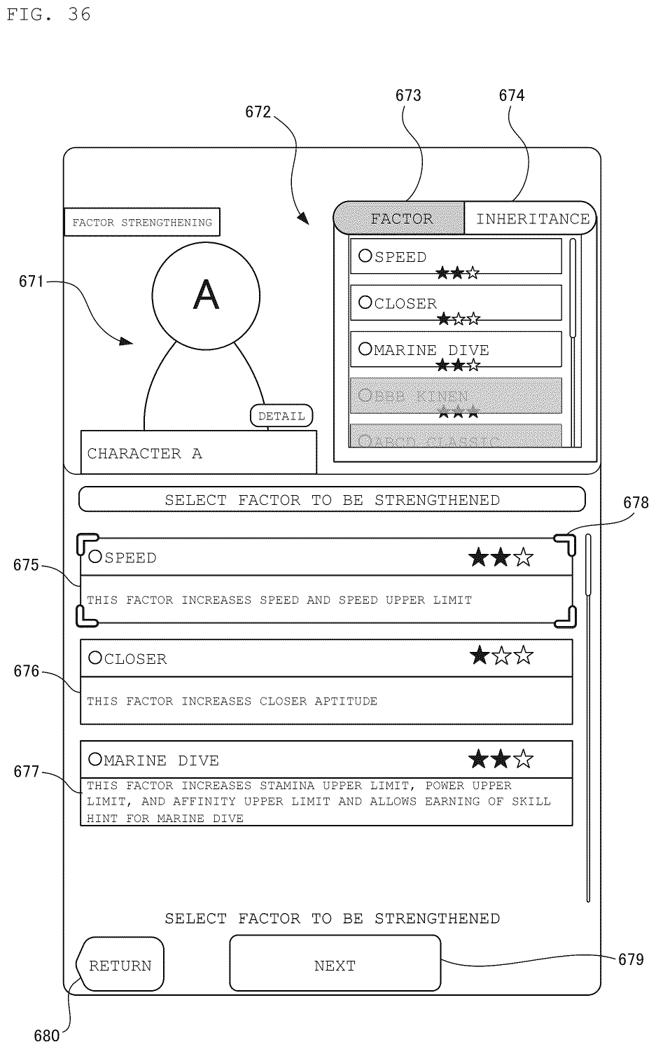

FIG. 36 is a drawing showing a display example of the strengthening-object selection screen. On the strengthening-object selection screen, an image of the nurtured character selected in the character selection process is displayed in a character display region 671, and factor information concerning the nurtured character selected in the character selection process and inheritance characters are displayed in a factor-related information display region 672. The display content of the factor-related information display region 672 can be switched by using a factor tab 673 and an inheritance tab 674.

In addition, a first selection button 675, a second selection button 676, and a third selection button 677 corresponding to the blue factor, the red factor, and the unique factor, respectively, of the selected nurtured character are provided on the strengthening-object selection screen. The first selection button 675 is a button for selecting a blue factor, indicating the kind (speed, stamina, power, spirit, and wisdom) of the performance parameter, the effect in an inheritance event, and the factor level (number of stars). The second selection button 676 is a button for selecting a red factor, indicating the kind of the aptitude (turf, dirt, short distance, mile, intermediate distance, long distance, pace maker, front runner, stalker, closer), the effect in an inheritance event, and the factor level (number of stars). The third selection button 677 is a button for selecting a unique factor, indicating the name of the unique skill, the effect in an inheritance event, and the factor level (number of stars). On the strengthening-object selection screen, a selection mark 678 is imparted to the selection button corresponding to the factor information being selected. Note that each of the first selection button 675, the second selection button 676, and the third selection button 677 is displayed normally on condition that the factor level of the corresponding factor information is not highest, and the selection buttons corresponding to factor information with the highest factor level appear grayed out.

When a tap input is made to a proceeding button 679 in a state in which the strengthening-object selection screen is displayed, factor information serving as a strengthening object is determined, the display screen transitions to a strengthening stage selection screen, and a strengthening-stage selection process for accepting selection of the strengthening stage of the factor information specified as a strengthening object is executed (step S307). Furthermore, when a tap input is made to a return button 680 in a state in which the strengthening-object selection screen is displayed, the display screen returns to the strengthening-object selection screen. Note that the proceeding button 679 is enabled on condition that a normally displayed selection button is being selected. For example, in the case where at least one of the blue factor, the red factor, and the unique factor includes factor information with the highest factor level and a grayed-out selection button is being selected, the proceeding button 679 also appears grayed out, thus prohibiting the display screen from transitioning to the strengthening stage selection screen even when a tap input is made to the proceeding button 679. Thus, this embodiment is controlled so that a transition to the strengthening stage selection screen is inhibited in a state in which factor information with the highest factor level, even though classified as the blue factor, the red factor, or the unique factor, is selected on the strengthening-object selection screen, thus imposing a limit on the selection of factor information.

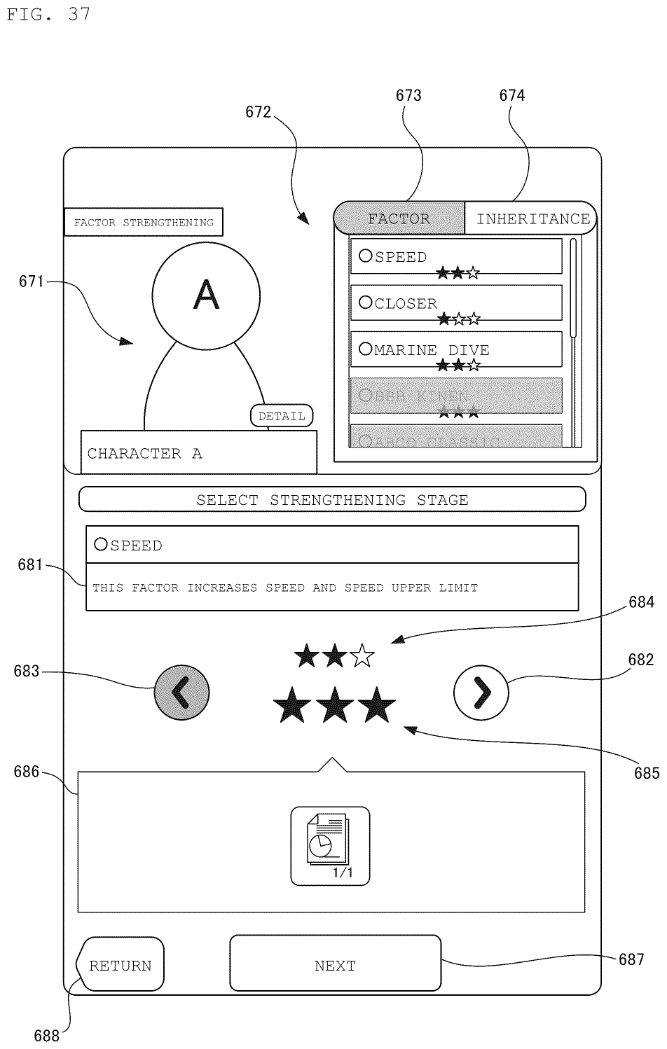

FIG. 37 is a drawing showing a display example of the strengthening stage selection screen. On the strengthening stage selection screen, similarly to the strengthening-object selection screen, an image of the nurtured character selected in the character selection process is displayed in the character display region 671, and factor information concerning the nurtured character selected in the character selection process and inheritance characters are displayed in the factor-related information display region 672. The display content of the factor-related information display region 672 can be switched by using the factor tab 673 and the inheritance tab 674.

In addition, on the strengthening stage selection screen, the factor information selected in the strengthening-object selection process is displayed in a strengthening object display region 681, and the content of change in the factor level of the factor information serving as a strengthening object is specified by using an increase button 682 and a decrease button 683. The increase button 682 and the decrease button 683 are enabled in the case where a change in the factor level is allowed and are disabled and appear grayed out in the case where a change in the factor level is not allowed as a result of the factor level reaching the lower limit of change in the factor level or the upper limit of change in the factor level (level 3=three stars). Note that, in this embodiment, the factor level of factor information serving as a strengthening object has a lower limit of change of (original factor level+1). That is, with the factor changing function, the factor level cannot be changed to a value below the original factor level.

Also, on the strengthening stage selection screen, the factor level before strengthening (original factor level) is displayed in the number of stars in a pre-strengthening level display region 684, and the factor level after strengthening is displayed in the number of stars in a post-strengthening level display region 685. In this embodiment, the factor level can be changed by a plurality of stages within the range of the number of possessed factor-changing items. More specifically, in the case where the factor level of factor information serving as a strengthening object is level 1 (one star) and the player possesses two or more factor-changing items, the player can raise the factor level by one stage to level 2 (two stars) by consuming one of the factor-changing items and raise the factor level by two stages to level 3 (three stars) by consuming two of the factor-changing items. In addition, in a factor-strengthening event of this embodiment, the number of times the factor changing function can be used is limited to up to five times during an event holding period. One use of the factor changing function is counted each time one factor-changing item is consumed. That is, raising the factor level of factor information serving as a strengthening object by two stages means to use the factor changing function twice.

Also, when a tap input is made to a proceeding button 687 in a state in which the strengthening stage selection screen is displayed, a strengthening content confirmation dialog is displayed, and a final confirmation process for making a final confirmation of the change in the factor information is executed (step S308). Furthermore, in the case where a tap input is made to a return button 688 in a state in which the strengthening stage selection screen is displayed, the display screen returns to the strengthening-object selection screen.

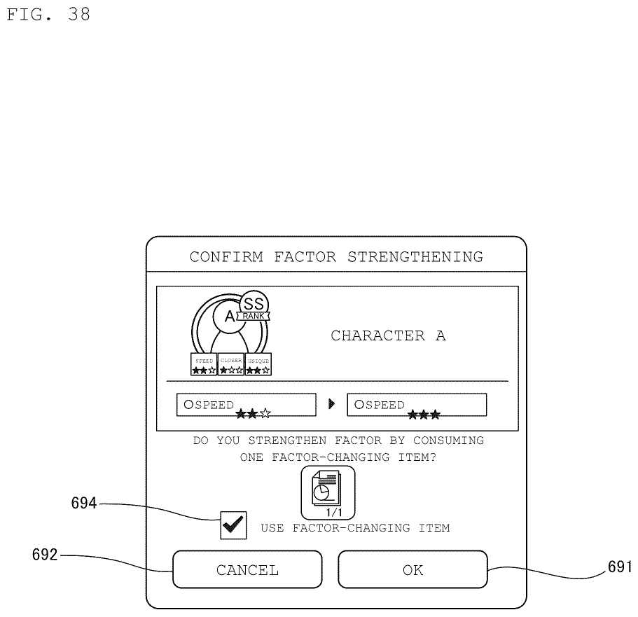

FIG. 38 is a drawing showing a display example of the strengthening content confirmation dialog. In the strengthening content confirmation dialog, the player can confirm a nurtured character the factor information of which is to be changed, the factor levels of the factor information serving as a strengthening object before and after they are strengthened, and the content of consumption of a factor-changing item. In the final confirmation process, a checkbox 694 is provided to deliberately confirm the player's intent, and a check mark is placed in the checkbox 694 by making a tap input to the checkbox 694, thereby enabling an OK button 691. In a state in which no check mark is placed in the checkbox 694, the OK button 691 is disabled and appears grayed out. When a tap input is made to the OK button 691 in a state in which the strengthening content confirmation dialog is displayed, a factor information change process is executed (step S309). Note that when a tap input is made to a cancel button 692 in a state in which the strengthening content confirmation dialog is displayed, the display screen returns to the strengthening stage selection screen.

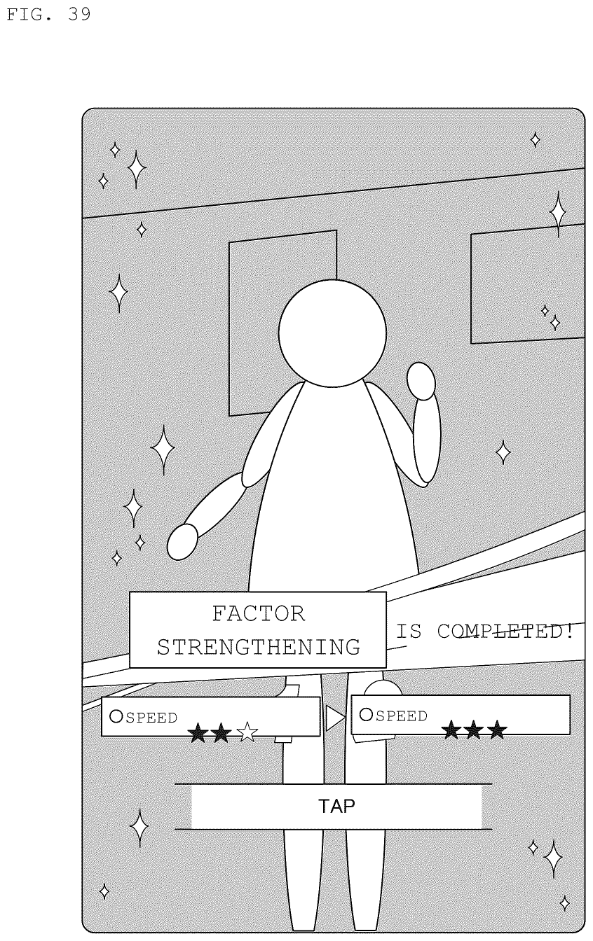

In the factor information change process, factor information of the nurtured character registered in the character list in the player data storage unit 71 is changed according to the content of change confirmed in the strengthening content confirmation dialog. More specifically, the factor ID of factor information serving as a strengthening object is overwritten. In this embodiment, a unique factor ID is assigned for each factor level of factor information with the same name. For example, the speed blue factor is assigned different factor IDs for different factor levels of level 1, level 2, and level 3. For this reason, the factor level can be changed by changing the factor ID. In addition, in the factor information change process, a factor information change request is transmitted from the player terminal 40 to the server 20. In the server 20 that has received the factor information change request, the factor IDs before and after the change are identified, the factor information of the corresponding nurtured character is changed, and the character list in the player management database 51 is updated. When the change in factor information is completed on the server 20 side, a change completion response is transmitted to the player terminal 40. In the player terminal 40 that has received the change completion response, completion notification presentation for reporting completion of change in factor information is executed, as shown in, for example, FIG. 39, thus ending a series of processing concerning the use of the factor changing function.

In the aforementioned information processing system 10 according to this embodiment, because factor information tied to a character on the basis of the result of character nurturing can be changed on condition that a factor-changing item is consumed, it is possible to reduce the player's burden of repeatedly executing character nurturing until factor information desired by the player is obtained.

In particular, in this embodiment, with reference to the statuses of the character serving as a nurturing object at the time the character nurturing is ended in the nurturing function, factor information to be tied to the character is decided. That is, in this embodiment, the player cannot know factor information to be tied to the character until character nurturing is ended in the nurturing function. For this reason, in the case where the time required to nurture one character is increased due to an increase in the content of the nurturing function, etc., there is risk of taking an enormous amount of time until factor information desired by the player is obtained. In this embodiment, however, even in the case where the content of factor information tied to a character at the time the character nurturing is ended is not what is desired by the player, it is expected that the time taken until the player can obtain a nurtured character with which factor information desired by the player is associated is reduced because the player can later change the factor information tied to the nurtured character.

Also, in this embodiment, in the case where a character is nurtured in the nurturing function, a factor inheritance event that affects statuses of the character serving as a nurturing object occurs according to the factor information tied to a nurtured character that was nurtured in the past. That is, this embodiment is designed so that it is easier to nurture a powerful character because a nurtured character to which excellent factor information is tied can be selected as an inheritance character. In addition, in this embodiment, because each player has a quota for nurtured characters that can be possessed, the player wishes to possess nurtured characters to which factor information as excellent as possible is tied. For this reason, if factor information tied to a character nurtured in the past can be changed as designed in this embodiment, it is possible to reduce the player's burden of carefully selecting whether or not to possess a nurtured character on the basis of the factor information tied to the character at the time nurturing of the character is ended.

Also, although the blue factor, the red factor, the unique factor, and the white factor are available as factor information to be tied to a nurtured character in this embodiment, the embodiment is controlled so that the blue factor, the red factor, and the unique factor can be changed in the factor changing function, whereas change in the white factor is not allowed.

That is, the factor changing function is applied to only some factor information, instead of applying it to all factor information. For this reason, in this embodiment, even if a desired factor level of the blue factor, the red factor, or the unique factor cannot be obtained at the time the nurturing of a character is ended, the obtained factor level can be changed later by using the factor changing function. In other words, this embodiment can provide a play environment in which even if the player cannot obtain a desired result of factor information tied to a character as a result of the character being nurtured, the player can accept the result of character nurturing.

Although this embodiment has been described by way of an example where the factor ID is changed as a method for raising the factor level, the kind and the factor level of a factor may be managed in different items of information so that the factor level can be raised by changing only the information concerning the factor level.

Also, although this embodiment has been described by way of an example where factor information can be changed by consuming a factor-changing item, the embodiment may be designed so that, instead of allowing the player to possess an item serving as a right to change factor information, the player, when a right to change factor information is earned by a reward decision lottery, may be informed so to change factor information. In addition, instead of randomly earning a right to change factor information by a reward decision lottery, the player may be allowed to obtain a right to change factor information in exchange for deletion of the white factor of a nurtured character the factor information of which is to be changed.

Furthermore, although this embodiment has been described by way of an example where the event parameter is accumulated by using the nurturing function and the competition function, the player may be allowed to accumulate the event parameter in exchange for deletion of a nurtured character from the character list.

Moreover, if an aspect of changing factor information is designed so as to allow the factor level to be raised by consuming a factor-changing item, the player does not need to be given a chance to re-earn factor information of a character for which nurturing is ended. Also, if an aspect of changing factor information is designed so as to allow the factor level to be raised by consuming a factor-changing item, factor information the factor level of which is raised by consuming the factor-changing item may be randomly decided.

In addition, changes in factor information include the player accepting and refusing factor information. The player may be allowed to edit factor information tied to a nurtured character by consuming a factor-changing item and re-register the character in the character list on the basis of the result of editing so as to tie the factor information to the character. For example, in exchange for the consumption of one factor-changing item, the player may be allowed to edit factor information so as to delete any white factor of factor information tied to a nurtured character and to raise the factor level of one of the remaining items of factor information. In this case, deletion of one item of factor information may cause the factor level of other factor information to be raised by one level, regardless of the factor level of the deleted factor information. In addition, the amount of level increase corresponding to the factor level of deleted factor information (e.g., three levels in the case where factor information with a factor level of level 3 is deleted) may be distributed to other factor information.

Furthermore, factor information that can be changed by using the factor changing function includes not only some but also all of the factor information tied to the nurtured character. This embodiment is designed so as to allow the player to change the blue factor, the red factor, and the unique factor of the blue factor, the red factor, the unique factor, and the white factor but so as not to allow the player to change the white factor. However, the embodiment may also be designed so as to allow the player to change the white factor by using the factor changing function.

A factor-strengthening event may be provided with a factor strengthening time period during which the factor changing function can be used and a reward earning time period during which a reward, such as a factor-changing item, can be earned. The factor strengthening time period may start after the reward earning time period has elapsed, or alternatively, a portion of the reward earning time period may overlap a portion of the factor strengthening time period, wherein the reward earning time period ends earlier, and the factor strengthening time period continues after the end of the reward earning time period. Note that each player may be allowed to possess and use a factor-changing item only in a time period during which a factor-strengthening event is held, and the factor-changing item can be deleted from the item list of each player after the end of the holding period.

In the case where a character is nurtured by using the nurturing function in a time period during which a factor-strengthening event is held, an event boost function for bringing about an effect advantageous in proceeding with the factor-strengthening event may be provided. This event boost function brings about an advantageous effect of a larger amount of increase in the event parameter and a larger number of earned rewards by consuming more trainer points (TP) needed in character nurturing than normally consumed ones. Use of the event boost function is decided at the player's discretion, and the nurturing function can be used in a state in which the event boost function is enabled by placing a check in a checkbox for confirming use of the event boost function when the nurturing function is to be used. In addition, in the case where the event boost function is used, a message indicating that an effect brought about by the event boost function is applied may be displayed during parameter update presentation and reward-earning presentation.

Note that the effect brought about by the event boost function may change according to whether or not another event is being held in a time period during which a factor-strengthening event is held. For example, in the case where no other events are being held in a time period during which a factor-strengthening event is held, the consumption of trainer points (TP) is doubled in character nurturing to use the event boost function, thereby bringing about an effect of doubling the amount of increase in the event parameter at the end of nurturing. On the other hand, in the case where another event is being held in a time period during which a factor-strengthening event is held, the consumption of trainer points (TP) in character nurturing is doubled to use the event boost function, thereby bringing about an effect of doubling the number of rewards earned in each of the events including the factor-strengthening event.

In addition, regarding the event boost function, the increase factor of consumption of trainer points (TP) and the increase factor of effect may be set for each event. For example, in the case where an event in which the consumption of trainer points (TP) is tripled and the number of earned rewards, such as items, is tripled is being held concurrently with an event in which the consumption of trainer points (TP) is doubled and the number of earned rewards, such as items, is tripled, the trainer points (TP) may be consumed by the event boost function according to the largest increase factor in the events, and the number of earned rewards may be increased by the event boost function according to the increase factor in each of the events.

Also, although this embodiment has been described by way of an example where factor information of a nurtured character nurtured by the current player himself/herself can be changed and factor information of inheritance characters used for the nurturing cannot be changed, it is also acceptable that factor information of inheritance characters can be changed.

In addition, regarding a nurtured character the factor information of which has been changed, factor information tied to the character at the time nurturing of the character is ended and the history of changes in factor information made by using the factor changing function are managed on the server 20 side. When it becomes necessary to display factor information concerning a nurtured character or apply the factor information at the player terminal 40, the player terminal 40 can receive, from the server 20, the factor information tied to the character at the time nurturing of the character is ended and the history of changes in factor information and reflect the history of changes in factor information on the factor information tied to the character at the time nurturing of the character is ended, thus displaying or applying the factor information concerning the nurtured character. For example, in the case where a character is nurtured by means of the nurturing function in a state in which a nurtured character the factor information of which has been changed is set as an inheritance character, factor information of the inheritance character can be applied on the basis of factor information tied to the character at the time nurturing is ended and the history of changes in factor information at the scene of applying the factor information of the inheritance character with an inheritance event or the like. Also, in the case where factor information concerning an inheritance-originated character of an inheritance character (nurtured character corresponding to the grandfather/grandmother generation of the character serving as a nurturing object) is to be applied, it is possible to apply factor information of the inheritance-originated nurtured character that was tied at the time the nurturing thereof was ended to the character serving as a nurturing object, instead of applying the history of changes in factor information. By doing so, it is possible to solve a problem in that as a result of factor information tied to a nurtured character registered in the character list being overwritten, another nurtured character that was nurtured by using the nurtured character as an inheritance character is affected. Note that in the case where factor information of a nurtured character the factor information of which has been changed is displayed at the player terminal 40, the manner for displaying stars indicating the factor level may be made to differ so that the difference between factor information tied at the time nurturing of the character is ended and the changed factor information can be recognized, or alternatively, stars indicating the factor level may be displayed in a display manner in which the difference cannot be recognized (display manner indicating only the changed factor level).

Although this embodiment has been described by way of an example of a game where two of the nurtured characters can be set as inheritance characters when a character is to be nurtured, the number of inheritance characters to be selected may be at least one, and this embodiment thus may also be realized such that three or more inheritance characters can be set. Furthermore, this embodiment may be configured such that each of the functions of the information processing system 10 is provided in another game. For example, this embodiment can be applied to a sport game, such as a baseball game and a soccer game, where a player can nurture characters to participate in a competition, hold a competition using the nurtured characters, reinforce statuses of a character to be newly nurtured by using nurtured characters, etc. Furthermore, this embodiment may be applied to games of other genres, such as an idol nurturing game, a romance simulation game, a card battle game, a battle game, an action game, a battle royal game, and a role-playing game, where a player can nurture characters, hold a competition using the nurtured characters, reinforce statuses of a character to be newly nurtured by using nurtured characters, etc.

1. A program for a game in which specific information tied to a nurtured game medium affects an ability of a game medium serving as a nurturing object, the program causing a computer to function as:
a specific information decision unit for deciding, on the basis of a result of nurturing the game medium serving as a nurturing object, the specific information to be tied to said game medium;
a parameter update unit for updating a specific parameter in the case where a game that uses the nurtured game medium is executed;
a change-right earning control unit for allowing earning of a right to change the specific information in the case where the specific parameter satisfies a predetermined condition; and
a specific information change unit for allowing the specific information tied to the nurtured game medium to be changed by consuming the right to change the specific information.

2. The program according to claim 1,
wherein the specific information change unit allows, on an input interface with which a change object of the specific information is selected, only the specific information belonging to a predetermined category to be selected as a change object.

3. The program according to claim 2,
wherein the specific information change unit does not allow selection of the specific information belonging to the predetermined category on the input interface if said specific information does not satisfy a change permission condition.

4. An information processing system for a game in which specific information tied to a nurtured game medium affects an ability of a game medium serving as a nurturing object, the information processing system comprising:
a specific information decision unit for deciding, on the basis of a result of nurturing the game medium serving as a nurturing object, the specific information to be tied to said game medium;
a parameter update unit for updating a specific parameter in the case where a game that uses the nurtured game medium is executed;
a change-right earning control unit for allowing earning of a right to change the specific information in the case where the specific parameter satisfies a predetermined condition; and
a specific information change unit for allowing the specific information tied to the nurtured game medium to be changed by consuming the right to change the specific information.

5. An information processing method for a game in which specific information tied to a nurtured game medium affects an ability of a game medium serving as a nurturing object, the information processing method causing a computer to execute:
a specific information decision step for deciding, on the basis of a result of nurturing the game medium serving as a nurturing object, the specific information to be tied to said game medium;
a parameter update step for updating a specific parameter in the case where a game that uses the nurtured game medium is executed;
a change-right earning control step for allowing earning of a right to change the specific information in the case where the specific parameter satisfies a predetermined condition; and
a specific information change step for allowing the specific information tied to the nurtured game medium to be changed by consuming the right to change the specific information.
